(19) United States
(12) Patent Application Publication
(10) Pub. No.: US 2026/0236508 A1
(43) Pub. Date: Aug. 13, 2026

(54) PARAMETER ACQUISITION SYSTEM

(71) Applicant: NTT DOCOMO, INC., Tokyo (JP)

(72) Inventors: Satsuki SHIMADA, Tokyo (JP); Norihiro KATSUMARU, Tokyo (JP); Syuusuke TATSUMI, Tokyo (JP)

(73) Assignee: NTT DOCOMO, INC., Tokyo (JP)

(21) Appl. No.: 19/151,677

(22) PCT Filed: Oct. 27, 2023
(86) PCT No.: PCT/JP2023/038973

§ 371 Date: Jul. 29, 2025

(30) Foreign Application Priority Data
Jan. 31, 2023 (JP) 2023-013275

(51) Int. Cl. G06F 16/334; G06F 16/335

(52) U.S. Cl. CPC G06F 16/3347; G06F 16/335

(57) ABSTRACT

A parameter acquisition system is a system that acquires a parameter set for a character to be activated in a virtual space, the system including a topic acquisition unit that acquires at least one topic in which closeness of a distance between a user embedding representation, which is an embedding representation in which a user is represented by a real number vector, and a topic embedding representation, which is an embedding representation in which a topic is represented by a real number vector, corresponds to a predetermined condition, a hobby acquisition unit that acquires a hobby corresponding to a topic acquired by the topic acquisition unit based on correspondence information representing a correspondence relationship between the topic and the hobby, and a setting information output unit that outputs a hobby acquired by the hobby acquisition unit as hobby information for setting the parameter of the character corresponding to the user.

### TECHNICAL FIELD

The present invention relates to a parameter acquisition system.

### BACKGROUND ART

For example, in a virtual space called a metaverse, characters are caused to perform activities such as moving around and dialogue, and thus communication between the characters is performed. In addition, a technique of learning an operation of an avatar by a user regarding behavior of the avatar in a virtual space and causing the avatar to behave to some extent based on a learning result autonomously is known (for example, refer to Patent Literature 1).

### CITATION LIST

### Patent Literature

[Patent Literature 1] Japanese Unexamined Patent Publication No. 2010-101950

### SUMMARY OF INVENTION

### Technical Problem

However, the behavior of the avatar based on the learning result of the operation by the user does not always appropriately reflect a personality of the user. In a so-called online state in which the user operates the character in the virtual space in real time, the character naturally performs an activity that reflects the personality of the user. As described above, the character operated by the user is referred to as, for example, a player character. On the other hand, a character that is not operated by the user (player) is referred to as a non-player character (NPC). The NPC includes not only a character in an offline state corresponding to a specific user but also a character that autonomously acts in the virtual space. The NPC performs activities such as moving around and dialogue in the virtual space based on information (parameter) constituting the personality of the character. For example, by applying a parameter constituting a personality of a character to a dialogue model for automatically generating a conversation, an utterance of the character can be generated. Therefore, in order to continue and activate the dialogue between the characters, it is necessary to set an appropriate parameter for the NPC.

Therefore, the present invention has been made in view of the above problems, and an object thereof is to obtain a parameter for suitably reflecting a personality of a user on a character to be activated in a virtual space.

### Solution to Problem

In order to solve the above-described problem, according to an aspect of the present disclosure, there is provided a parameter acquisition system that acquires a parameter set for a character to be activated in a virtual space, the system including a topic acquisition unit that acquires at least one topic in which closeness of a distance between a user embedding representation, which is an embedding representation in which a user is represented by a real number vector, and a topic embedding representation, which is an embedding representation in which a topic is represented by a real number vector, corresponds to a predetermined condition, a hobby acquisition unit that acquires a hobby corresponding to a topic acquired by the topic acquisition unit based on correspondence information representing a correspondence relationship between the topic and the hobby, and a setting information output unit that outputs a hobby acquired by the hobby acquisition unit as hobby information for setting the parameter of the character corresponding to the user.

According to the above aspect, since the distance between the user and the topic can be calculated based on the user embedding representation and the topic embedding representation in which each of the features of the user and the topic is represented, the topic in which the closeness of the distance to the user corresponds to a predetermined condition can be acquired. The hobby corresponding to the topic is acquired based on the correspondence information. Therefore, the acquired hobby has a certain degree or more of closeness to the user. The acquired hobby is output as the hobby information, so that the hobby information can be applied to a parameter for setting the character of the user.

### Advantageous Effects of Invention

It is possible to obtain the parameter for suitably reflecting the personality of the user on the character to be activated in the virtual space.

### BRIEF DESCRIPTION OF DRAWINGS

FIG. 1 is a block diagram illustrating a functional configuration of a parameter acquisition device according to the present embodiment.

FIG. 2 is a hardware block diagram of the parameter acquisition device and an embedding representation generation device.

FIG. 3 is a diagram schematically illustrating a step of acquiring an embedding representation.

FIG. 4 is a diagram illustrating an example of a topic acquired based on a distance between a user embedding representation and a topic embedding representation.

FIG. 5 is a diagram illustrating an example of a given hobby list including a hobby word.

FIG. 6 is a diagram illustrating an example of correspondence information defining a correspondence relationship between a hobby and a topic.

FIG. 7 is a diagram illustrating an example of a thesaurus that includes a topic word and a hobby word and is hierarchically configured as an example of correspondence information.

FIG. 8 is a diagram illustrating an example of a calculation of a degree of similarity between a topic word and a hobby word as an example of correspondence information.

FIG. 9 is a diagram schematically illustrating an output of hobby information for setting as a parameter of a character.

FIG. 10 is a diagram illustrating an example of an attribute list in which a hobby and attribute information are associated with each other.

FIG. 11 is a diagram schematically illustrating an output of hobby information and attribute information for setting as a parameter of a character.

FIG. 12 is a flowchart illustrating the processing contents of a parameter acquisition method in the parameter acquisition device.

FIG. 13 is a diagram illustrating a configuration of a parameter acquisition program.

FIG. 14 is a block diagram illustrating a functional configuration of an embedding representation generation device according to the present embodiment.

FIG. 15 is a diagram schematically illustrating a step of acquiring an utterance text.

FIG. 16 is a diagram illustrating a configuration of a language model and an example of a machine learning process of the language model.

FIG. 17 is a diagram illustrating an example of embedding representation acquisition processing using an embedding unit of a learned language model.

FIG. 18 is a diagram illustrating an example of acquisition of an edge for generating a relationship graph.

FIG. 19 is a diagram illustrating an example of a relationship graph and an example of extraction of a positive example and a negative example from the relationship graph.

FIG. 20 is a diagram illustrating an example of an embedding representation of each entity obtained by learning a graph neural network constituting a relationship graph.

FIG. 21 is a flowchart illustrating the processing contents of an embedding representation generation method in the embedding representation generation device.

FIG. 22 is a flowchart illustrating the processing contents of machine learning of a language model.

FIG. 23 is a diagram illustrating a configuration of an embedding representation generation program.

### DESCRIPTION OF EMBODIMENTS

Embodiments of a parameter acquisition system according to the present invention will be described with reference to the drawings. If possible, the same components are denoted by the same reference numerals, and duplicated descriptions will be omitted.

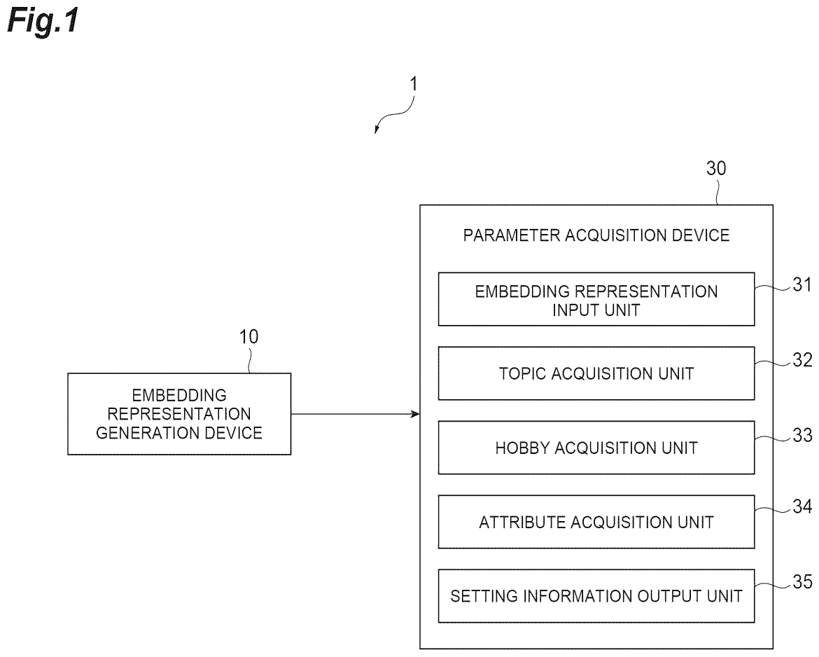

FIG. 1 is a diagram illustrating a functional configuration of a parameter acquisition system according to the present embodiment. A parameter acquisition system 1 of the present embodiment is a system that acquires parameters to be set for a character to be activated in a virtual space, and is configured with, for example, a parameter acquisition device 30. In addition, the parameter acquisition system 1 may further include an embedding representation generation device 10.

The parameter acquisition device 30 is a device that acquires parameters to be set for a character to be activated in a virtual space, and functionally includes an embedding representation input unit 31, a topic acquisition unit 32, a hobby acquisition unit 33, an attribute acquisition unit 34, and a setting information output unit 35, as illustrated in FIG. 1. Each of functional units 31 to 35 only needs to be configured in one device, as illustrated in FIG. 1, or only needs to be configured to be distributed in a plurality of devices.

The embedding representation generation device 10 is a device that generates at least embedding representations of a user and a topic. In the example illustrated in FIG. 1, the embedding representation generation device 10 is illustrated as a device different from the parameter acquisition device 30, and only needs to be configured integrally with the parameter acquisition device 30. A function of the embedding representation generation device 10 will be described later.

The block diagram illustrated in FIG. 1 illustrates blocks of functional units. These functional blocks (components) are implemented by any combination of at least one of hardware or software. In addition, a method of implementing each functional block is not particularly limited. That is, each functional block only needs to be implemented by using one device that is physically or logically coupled, or only needs to be implemented by connecting two or more devices that are physically or logically separated directly or indirectly (for example, using wired or wireless connections), and using these plurality of devices. The functional block only needs to be implemented by combining software with one device or the plurality of devices described above.

The functions include determining, determining, judging, calculating, computing, processing, deriving, investigating, looking up, search, inquiry, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, and assigning, but are not limited thereto. For example, the functional block (component) that functions to perform transmission is referred to as a transmitting unit or a transmitter. In any case, as described above, the method of implementing the above-described method is not particularly limited.

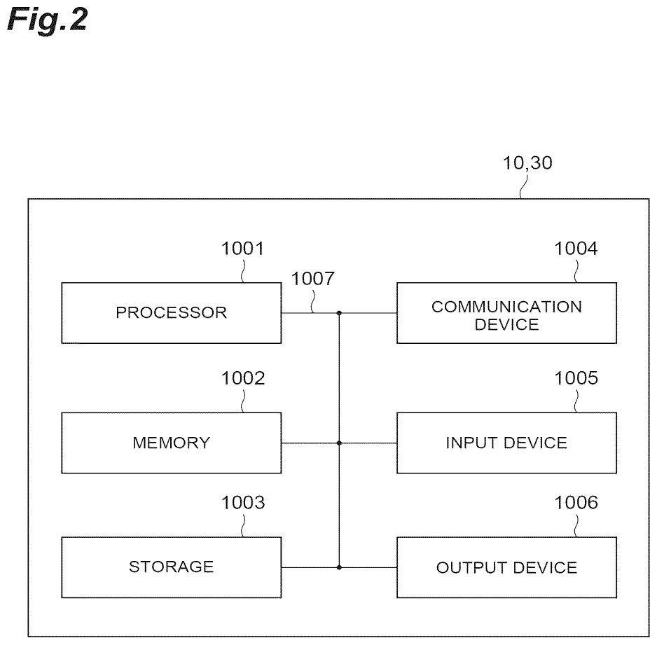

For example, the parameter acquisition device 30 in the embodiment of the present invention may function as a computer. In addition, the embedding representation generation device 10 may function as a computer. FIG. 2 is a diagram illustrating an example of a hardware configuration of the parameter acquisition device 30 according to the present embodiment. In addition, the hardware configuration of the embedding representation generation device 10 is also illustrated in FIG. 2 in the same manner. The parameter acquisition device 30 and the embedding representation generation device 10 only need to physically be configured as a computer device including a processor 1001, a memory 1002, a storage 1003, a communication device 1004, an input device 1005, an output device 1006, a bus 1007, and the like.

In the following description, the term “device” can be interpreted as a circuit, a device, a unit, or the like. The hardware configurations of the parameter acquisition device 30 and the embedding representation generation device 10 only need to be configured to include one or a plurality of devices illustrated in the drawing, or only need to be configured to exclude a part of the devices.

Each function of the parameter acquisition device 30 and the embedding representation generation device 10 is implemented by causing the processor 1001 to perform a calculation by reading predetermined software (program) on hardware such as the processor 1001 and the memory 1002, and controlling the communication by the communication device 1004 and the readout and/or write-in of data in the memory 1002 and the storage 1003.

The processor 1001 controls the entire computer by, for example, operating an operating system. The processor 1001 only needs to be configured with a central processing unit (CPU) including an interface with a peripheral device, a control device, an arithmetic device, a register, and the like. For example, each of the functional units 31 to 35 illustrated in FIG. 1 and each functional unit of the embedding representation generation device 10 only needs to be implemented by the processor 1001.

In addition, the processor 1001 reads a program (program code), a software module, and data from the storage 1003 and/or the communication device 1004 to the memory 1002, and executes various processes according to the program. As the program, a program is used that causes a computer to execute at least a part of the operation described in the above embodiment. For example, each functional unit 31 to 35 of the parameter acquisition device 30 and the functional unit of the embedding representation generation device 10 only needs to be stored in the memory 1002 and only needs to be implemented by a control program that is operated by the processor 1001. Although a gist that various types of processing described above are executed by one processor 1001 is described, the processing only needs to be executed simultaneously or sequentially by two or more processors 1001. The processor 1001 only needs to be implemented with one or more chips. The program only needs to be transmitted from a network via a telecommunication line.

The memory 1002 is a computer-readable recording medium, and only needs to be configured with at least one of a read only memory (ROM), an erasable programmable ROM (EPROM), an electrically erasable programmable ROM (EEPROM), and a random access memory (RAM). The memory 1002 only needs to be referred to as a register, a cache, a main memory (main storage device), and the like. The memory 1002 can store an executable program (program code), a software module, and the like for executing a parameter generation method according to the embodiment of the present invention.

The storage 1003 is a computer-readable recording medium, and only needs to be configured with, for example, at least one of an optical disk such as a compact disc ROM (CD-ROM), a hard disk drive, a flexible disk, a magneto-optical disk (for example, a compact disk, a digital versatile disk, a Blu-ray (Registered trademark) disk), a smart card, a flash memory (for example, a card, a stick, or a key drive), a floppy (registered trademark) disk, and a magnetic strip. The storage 1003 only needs to be referred to as an auxiliary storage device. The above-described storage medium only needs to be, for example, a database including the memory 1002 and/or the storage 1003, a server, or another suitable medium.

The communication device 1004 is a hardware (transmission/reception device) for performing communication between the computers through a wired and/or wireless network, and is also referred to as, for example, a network device, a network controller, a network card, a communication module, or the like.

The input device 1005 is an input device (for example, a keyboard, a mouse, a microphone, a switch, a button, a sensor, and the like) that receives an input from the outside. The output device 1006 is an output device (for example, a display, a speaker, an LED lamp, and the like) that performs output to the outside. The input device 1005 and the output device 1006 only need to be configured integrally (for example, a touch panel).

In addition, each device, such as the processor 1001 or the memory 1002, is connected by a bus 1007 for communicating information. The bus 1007 only needs to be configured with a single bus, or only needs to be configured with different buses between the devices.

In addition, the parameter acquisition device 30 may include hardware such as a microprocessor, a digital signal processor (DSP), an application-specific integrated circuit (ASIC), a programmable logic device (PLD), or a field programmable gate array (FPGA), and some or all of the functional blocks only need to be implemented by the hardware. For example, the processor 1001 only needs to be implemented by at least one of the hardware.

Next, each functional unit of the parameter acquisition device 30 will be described. The embedding representation input unit 31 acquires a user embedding representation, which is an embedding representation of a user, and a topic embedding representation, which is an embedding representation of a topic. The user embedding representation is an embedding representation that is represented by a real number vector and reflects a feature of the user. The topic embedding representation is an embedding representation that is represented by a real number vector and reflects the feature of the topic. In addition, since the relationship between the user embedding representation and the topic embedding representation acquired by the embedding representation input unit 31 is reflected by a predetermined method, it is possible to calculate the distance between the user and the topic.

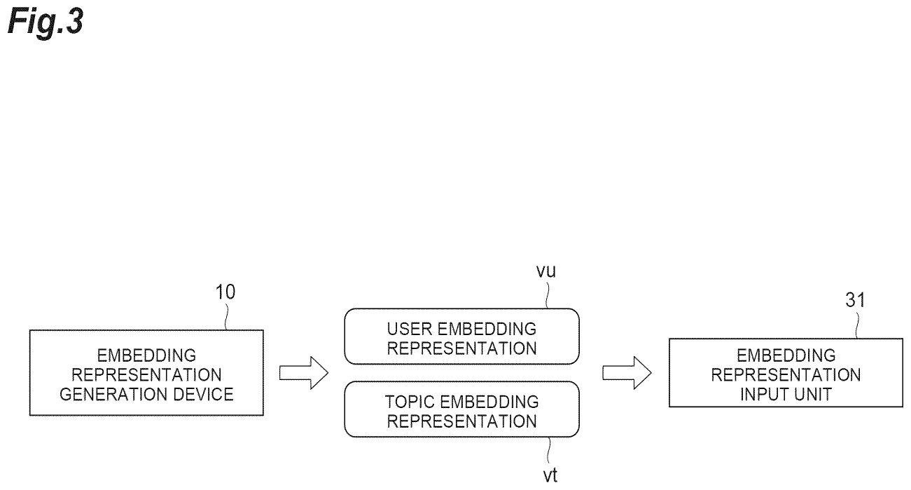

FIG. 3 is a diagram schematically illustrating a step of acquiring an embedding representation. As illustrated in FIG. 3, the embedding representation input unit 31 may acquire a user embedding representation vu and a topic embedding representation vt from the embedding representation generation device 10. As will be described later, the embedding representation generation device 10 generates the user embedding representation vu and the topic embedding representation vt in which each of the features of the user and the topic is represented and the relationship between the user and the topic is appropriately reflected.

The topic acquisition unit 32 acquires at least one topic in which the closeness of the distance between the user embedding representation of the user and the topic embedding representation of the topic corresponds to a predetermined condition. Specifically, the topic acquisition unit 32 may calculate a distance between the user embedding representation of the user and each of the topic embedding representations of a plurality of topics, and acquire a predetermined number of topics in which the closeness of the calculated distance is high level.

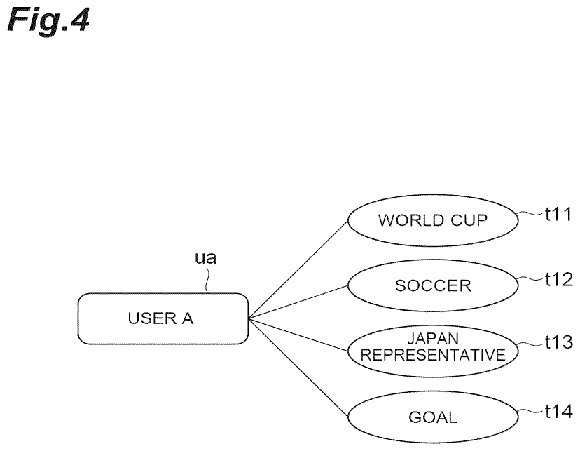

FIG. 4 is a diagram illustrating an example of a topic acquired based on a distance between a user embedding representation and a topic embedding representation. In the example illustrated in FIG. 4, the topic acquisition unit 32 calculates a distance between the user embedding representation vu of a user A and each of the topic embedding representations vt of the plurality of topics acquired by the embedding representation input unit 31, and acquires the topics t11 (World Cup), t12 (soccer), t13 (Japan representative), and t14 (goal) of a predetermined number of the topic embedding representations vt in which the closeness of the distance is high level (high level of four in the example of FIG. 4). As a result, it is possible to extract a topic that is highly likely to have a close relationship with the user.

In addition, the topic acquisition unit 32 may acquire a topic in which a distance between the user embedding representation vu of the user and the topic embedding representation vt of the topic is equal to or less than a predetermined degree. Specifically, the topic acquisition unit 32 calculates the distance between the user embedding representation vu of the user A and each of the topic embedding representations vt of the plurality of topics acquired by the embedding representation input unit 31, and acquires the topic of the topic embedding representation vt in which the calculated distance is equal to or less than a given threshold value. As a result, a topic having a suitable closeness at a distance to the user is acquired.

With reference to FIG. 1 again, the hobby acquisition unit 33 acquires the hobby corresponding to the topic acquired by the topic acquisition unit 32 based on correspondence information representing the correspondence relationship between the topic and the hobby. Specifically, the hobby acquisition unit 33 acquires the hobby corresponding to the topic acquired by the topic acquisition unit 32 with reference to a thesaurus as correspondence information based on a given hobby list including a plurality of hobby words representing hobbies.

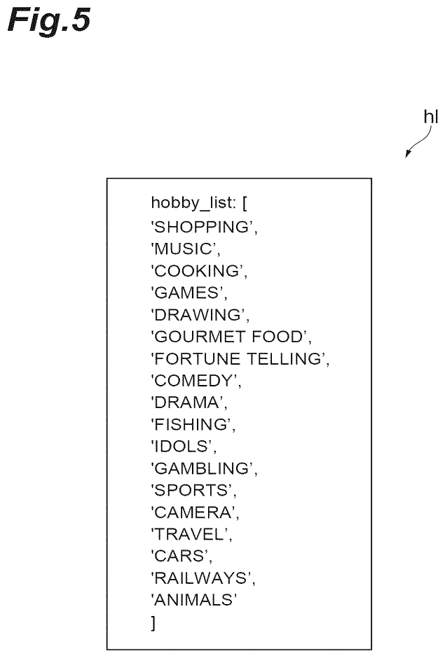

FIG. 5 is a diagram illustrating an example of a given hobby list including a hobby word. The hobby list only needs to be set in advance and stored in predetermined storage means (for example, the storage 1003). As illustrated in FIG. 5, a hobby list h1 includes hobby words “shopping”, “music”, “cooking”, “games”, and the like representing hobbies as a list.

A thesaurus is generally information constituting a dictionary in which words are classified and organized by high level/low level relationships, partial/whole relationships, synonymous relationships, similar relationships, and the like of words. In the present embodiment, the hobby acquisition unit 33 refers to a thesaurus that defines a relationship between a plurality of words including at least a hobby word and a topic word, as correspondence information. The thesaurus only needs to be set in advance and stored in predetermined storage means (for example, the storage 1003).

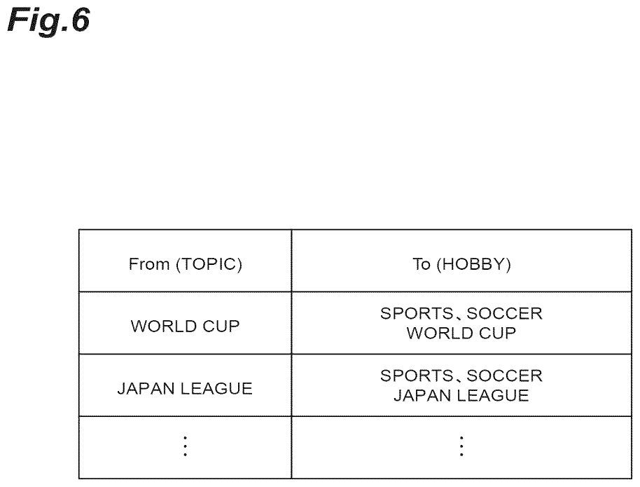

The hobby acquisition unit 33 may extract a hobby word related to the topic word with reference to the thesaurus, and generate a map indicating a correspondence relationship between the extracted topic word and hobby word as correspondence information. FIG. 6 is a diagram illustrating an example of a map in which a correspondence relationship between a hobby and a topic is defined. As illustrated in FIG. 6, the map associates, for example, the topic word “World Cup” with the hobby words “sports”, “soccer”, and “World Cup”.

The hobby acquisition unit 33 may extract the hobby word associated with the topic word representing the topic acquired by the topic acquisition unit 32 with reference to the map illustrated in FIG. 6, and acquire the hobby represented by the hobby word.

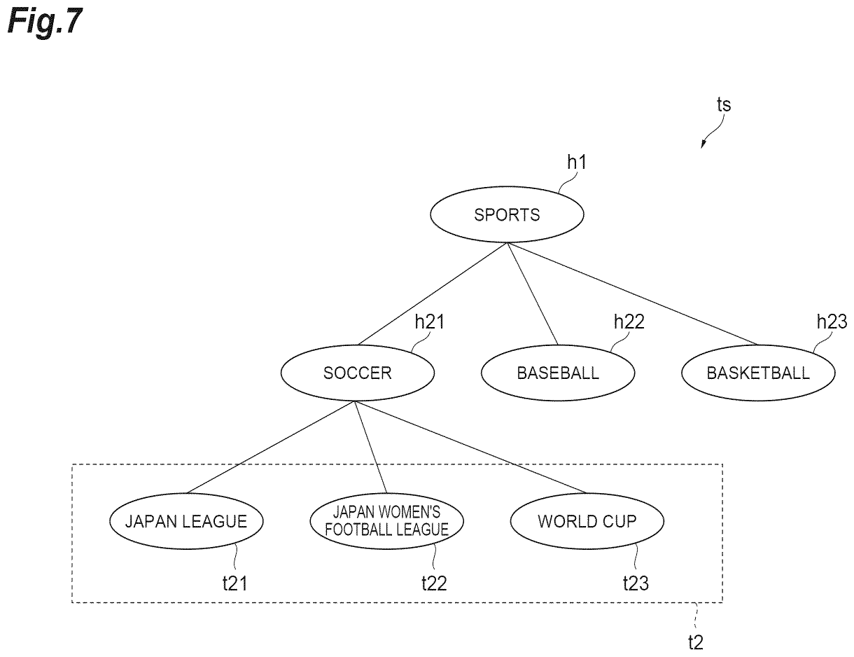

FIG. 7 is a diagram illustrating an example of a thesaurus that includes a topic word and a hobby word and is hierarchically configured as an example of correspondence information. A thesaurus ts is information in which the relationship between the hobby words h1, h21 to h23, and the topic word t2 is hierarchically defined. In addition, the thesaurus ts only needs to be configured to include topic words t21, t22, and t23 indicating topics uttered by the user in the virtual space.

When the topic “World Cup” is acquired by the topic acquisition unit 32, the hobby acquisition unit 33 acquires the hobby word h21 “soccer” associated with the upper level of the topic word t23 “World Cup” with reference to the thesaurus ts.

In a case where the hobby word is acquired with reference to the thesaurus having the hierarchical structure, the hobby acquisition unit 33 may further acquire the hobby word associated with the upper level or the lower level of the acquired hobby word. That is, in the example illustrated in FIG. 7, the hobby acquisition unit 33 may further acquire the hobby word h1 “sports” associated with the upper level of the acquired hobby word h21 “soccer”.

As described above, with reference to the correspondence information configured with the thesaurus that defines the relationship between the words representing the hobby and the topic, the corresponding hobby word is extracted based on the topic word representing the topic having a close relationship with the user. Therefore, the hobby represented by the hobby word can be output as hobby information having a close relationship with the user.

The hobby acquisition unit 33 may acquire the hobby by using the degree of similarity between the topic word and the hobby word as correspondence information. Specifically, the hobby acquisition unit 33 refers to a given hobby list h1 including a plurality of hobby words representing hobbies, and calculates a degree of similarity between each of the topic words representing the topics acquired by the topic acquisition unit 32 and the hobby word included in the hobby list h1 as correspondence information.

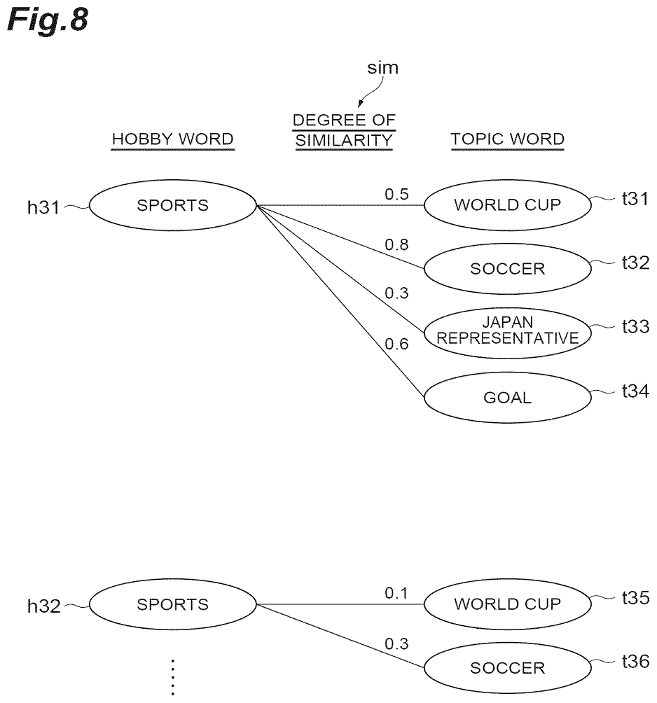

FIG. 8 is a diagram illustrating an example of a calculation of a degree of similarity between a topic word and a hobby word as an example of correspondence information. As illustrated in FIG. 8, the hobby acquisition unit 33 calculates a degree of similarity sim between each of the topic words t31 to t36, . . . representing the topics acquired by the topic acquisition unit 32 and the hobby words h31, h32, . . . included in the hobby list h1. A method of calculating a degree of similarity between the words is not limited, and the hobby acquisition unit 33 may calculate a degree of similarity between the topic word and the hobby word using Word2Vec. According to Word2Vec, the degree of similarity between the hobby word and the topic word can be accurately calculated.

The hobby acquisition unit 33 acquires the hobby corresponding to the hobby word of which the calculated degree of similarity is equal to or greater than a given threshold value. For example, in a case where “0.7” is given as a given threshold value related to the degree of similarity, the hobby acquisition unit 33 extracts the hobby word h31 “sports” having a degree of similarity of 0.8 with the topic word t32 “soccer”, and acquires the hobby “sports” represented by the extracted hobby word “sports”.

As described above, the hobby represented by the hobby word having a high degree of similarity to the topic word representing the topic having a close relationship with the user is acquired. Therefore, the hobby having a close relationship with the user can be output as hobby information.

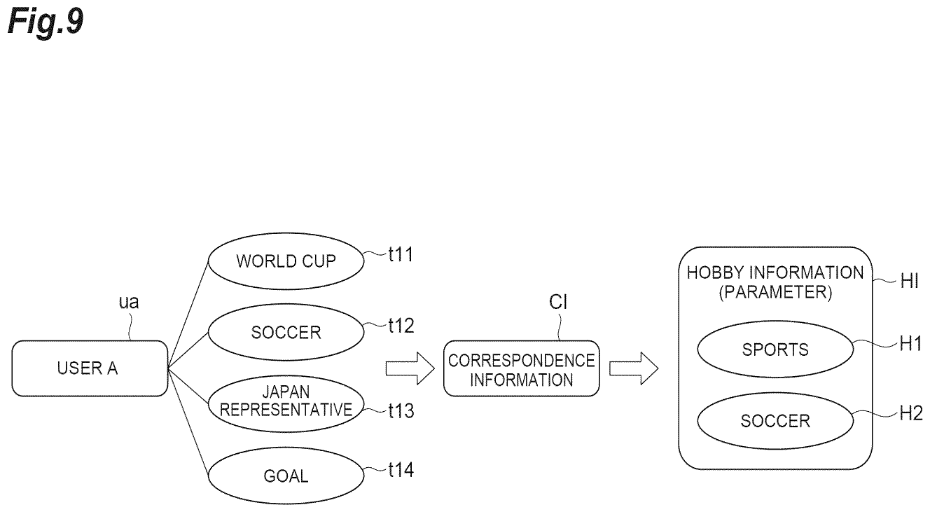

FIG. 9 is a diagram schematically illustrating an output of hobby information for setting as a parameter of a character. As described with reference to FIGS. 4 to 8, the topic acquisition unit 32 acquires the topics t11 to t14 having a close relationship with the user A (ua) based on the distance between the user embedding representation vu and the topic embedding representation vt. The hobby acquisition unit 33 acquires hobbies H1 and H2 corresponding to the topics t11 to t14 acquired by the topic acquisition unit 32 based on correspondence information CI representing a correspondence relationship between the topic and the hobby.

The setting information output unit 35 outputs the hobbies H1 and H2 acquired by the hobby acquisition unit 33 as the hobby information H1 for setting the parameter of the character corresponding to the user A in the virtual space. An aspect of outputting is not limited, and the setting information output unit 35 may set a parameter related to the hobby in the character of the user A based on the hobby information HI. In addition, the setting information output unit 35 may store the hobby information HI in predetermined storage means.

With reference to FIG. 1 again, the parameter acquisition device 30 may further include an attribute acquisition unit 34. The attribute acquisition unit 34 acquires attribute information associated with the hobby acquired by the hobby acquisition unit 33 with reference to a given attribute list. For example, the attribute list is information in which a hobby is associated with attribute information on a person in advance.

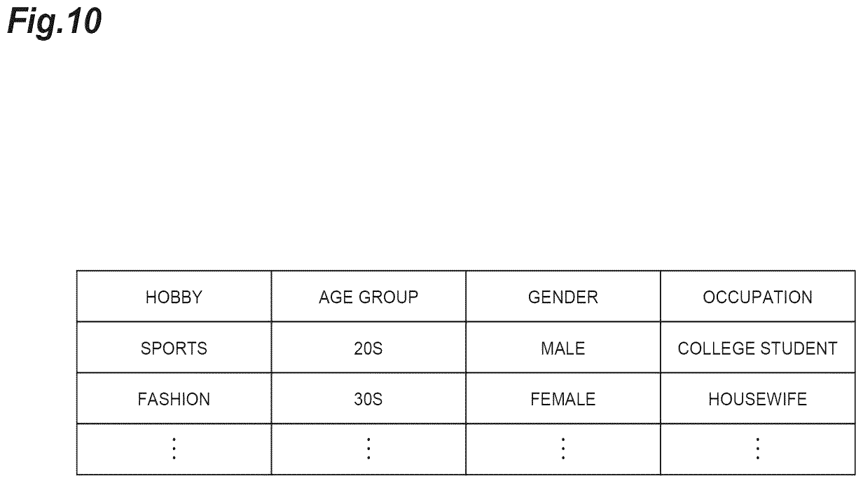

FIG. 10 is a diagram illustrating an example of an attribute list. The attribute list only needs to be set in advance and stored in predetermined storage means (for example, the storage 1003). As illustrated in FIG. 10, the attribute list stores attributes of the user such as an age group, gender, and occupation in association with a hobby. That is, the attribute list stores various attributes that are highly likely to correspond to a user having a certain hobby in association with the hobby. For example, the attribute list stores attributes such as “20s”, “male”, and “college student” in association with the hobby “sports”.

In a case where the hobby “sports” is acquired as the hobby information on the user A by the hobby acquisition unit 33, the attribute acquisition unit 34 acquires the attributes “20s”, “male”, and “college student” associated with the hobby “sports” in the attribute list.

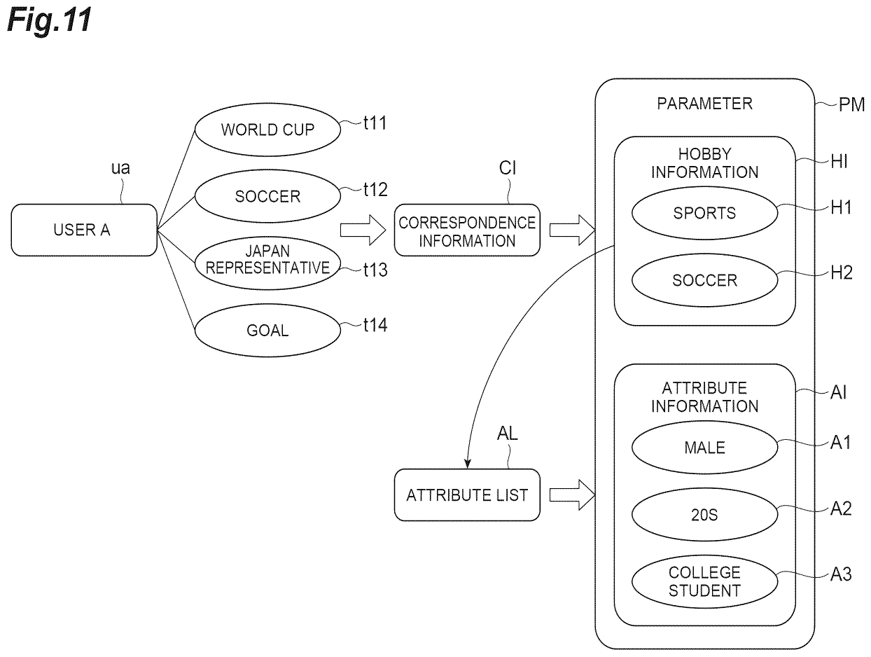

FIG. 11 is a diagram schematically illustrating an output of hobby information and attribute information for setting as a parameter of a character. As illustrated in FIG. 11, the topic acquisition unit 32 acquires topics t11 to t14 having a close relationship with the user A (ua) based on the distance between the user embedding representation vu and the topic embedding representation vt. The hobby acquisition unit 33 acquires hobbies H1 and H2 corresponding to the topics t11 to t14 acquired by the topic acquisition unit 32 based on correspondence information CI representing a correspondence relationship between the topic and the hobby.

Furthermore, the attribute acquisition unit 34 acquires, for example, the attribute information A1 to A3 associated with the hobby information H1 “sports” among the hobby information acquired by the hobby acquisition unit 33, with reference to the attribute list AL in which the hobby and the attribute information are associated with each other.

The setting information output unit 35 outputs the hobbies H1 and H2 acquired by the hobby acquisition unit 33 as the hobby information HI for setting the parameter PM of the character corresponding to the user A in the virtual space. Furthermore, the setting information output unit 35 outputs the attribute information AI including the attributes A1 to A3 acquired by the attribute acquisition unit 34 as information for setting the parameter PM of the character corresponding to the user A in the virtual space.

An aspect of outputting is not limited, and the setting information output unit 35 may set the parameter related to the hobby and the attribute in the character of the user A based on the hobby information HI and the attribute information AI. In addition, the setting information output unit 35 may store the hobby information HI and the attribute information AI in predetermined storage means.

The topic acquisition unit 32 may acquire a topic that is close to a distance for all users who act in the virtual space. Specifically, the topic acquisition unit 32 may acquire the topics commonly extracted from a predetermined number or more of users. In addition, the topic acquisition unit 32 may extract a predetermined number of topics in which the closeness of distance is high level to all users, or a predetermined ratio, or a predetermined number of users among all users. The topic acquisition unit 32 outputs the topics extracted for all users as hobby information for setting as a parameter related to the hobby of the character to be activated in the virtual space. The hobby information output based on all users in this manner only needs to be set to a parameter of an NPC that does not correspond to the specific user, for example. Furthermore, the attribute acquisition unit 34 may acquire the attribute information with reference to the attribute list based on the hobby information output based on all the users, and output the acquired attribute information as information for setting the parameter of the NPC that does not correspond to the specific user.

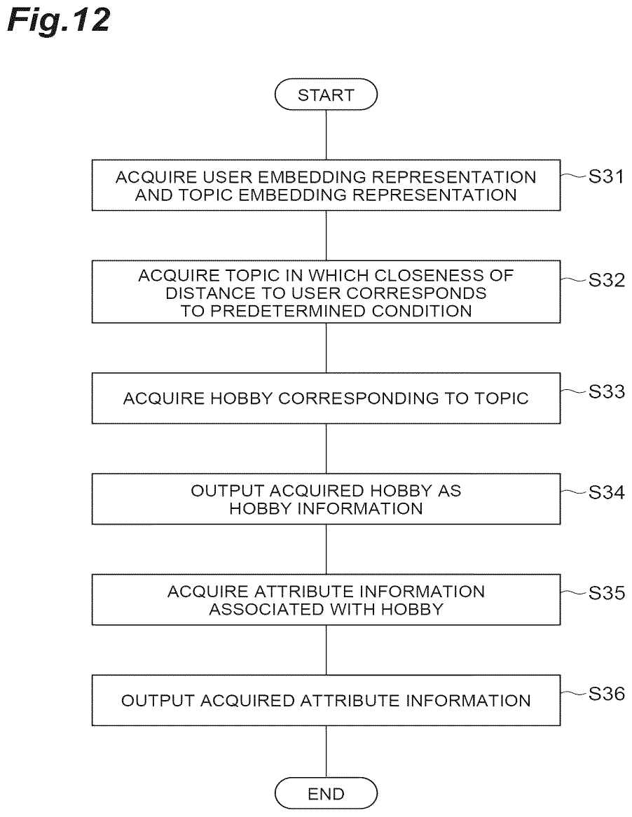

FIG. 12 is a flowchart illustrating the processing contents of a parameter acquisition method in the parameter acquisition device 30.

In step S31, the embedding representation input unit 31 acquires a user embedding representation, which is an embedding representation of the user, and a topic embedding representation, which is an embedding representation of the topic.

In step S32, the topic acquisition unit 32 acquires at least one topic in which the closeness of the distance between the user embedding representation of the user and the topic embedding representation of the topic corresponds to a predetermined condition.

In step S33, the hobby acquisition unit 33 acquires the hobby corresponding to the topic acquired by the topic acquisition unit 32 based on correspondence information representing a correspondence relationship between the topic and the hobby.

In step S34, the setting information output unit 35 outputs the hobby acquired by the hobby acquisition unit 33 as the hobby information for setting the parameter of the character corresponding to the user in the virtual space.

In step S35, the attribute acquisition unit 34 acquires the attribute information associated with the hobby acquired by the hobby acquisition unit 33 with reference to the given attribute list.

In step S36, the setting information output unit 35 outputs the attribute information acquired by the attribute acquisition unit 34 as information for setting the parameter of the character corresponding to the user in the virtual space.

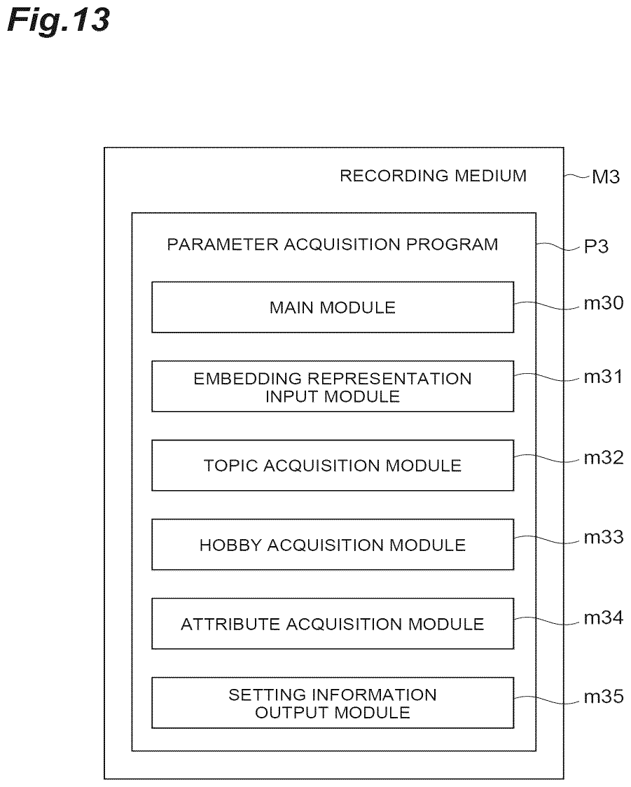

Next, a parameter acquisition program for causing the computer to function as the parameter acquisition device 30 according to the present embodiment will be described with reference to FIG. 13. FIG. 13 is a diagram illustrating a configuration of a parameter acquisition program. A parameter acquisition program P3 is configured to include a main module m30 that integrally controls parameter acquisition processing in the parameter acquisition device 30, an embedding representation input module m31, a topic acquisition module m32, a hobby acquisition module m33, an attribute acquisition module m34, and a setting information output module m35. Each function for each of the functional units 31 to 35 is implemented by each of the modules m31 to m35.

The parameter acquisition program P3 only needs to be in an aspect that is transmitted via a transmission medium such as a communication line, or only needs to be in an aspect that is stored in a recording medium M3, as illustrated in FIG. 13.

According to the parameter acquisition device 30, the parameter acquisition method, and the parameter acquisition program P3 of the present embodiment described above, since the distance between the user and the topic can be calculated based on the user embedding representation and the topic embedding representation, each of which represents the user and the feature of the topic, it is possible to acquire the topic in which the closeness of the distance to the user corresponds to the predetermined condition. The hobby corresponding to the topic is acquired based on the correspondence information. Therefore, the acquired hobby has a certain degree or more of closeness to the user. The acquired hobby is output as the hobby information, so that the hobby information can be applied to a parameter for setting the character of the user.

### (Embedding Representation Generation Device)

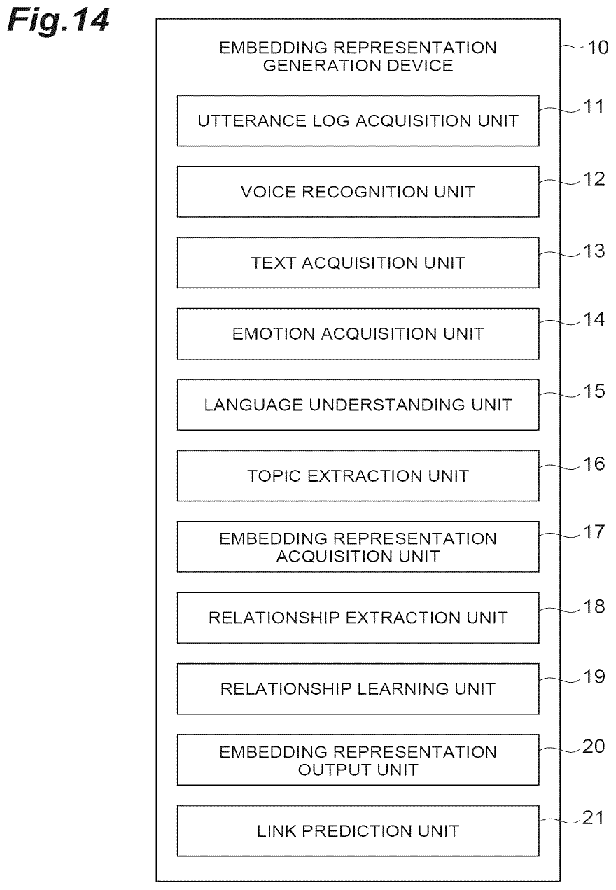

Next, the embedding representation generation device 10 illustrated in FIG. 1 will be described. The embedding representation generation device 10 can obtain an embedding representation of an entity in which a relationship between different entities is appropriately represented. FIG. 14 is a diagram illustrating a functional configuration of the embedding representation generation device 10 according to the present embodiment. The embedding representation generation device 10 according to the present embodiment is a device that generates at least the embedding representations of the user and the topic.

As illustrated in FIG. 14, the embedding representation generation device 10 includes, functionally, an utterance log acquisition unit 11, a voice recognition unit 12, a text acquisition unit 13, an emotion acquisition unit 14, a language understanding unit 15, a topic extraction unit 16, an embedding representation acquisition unit 17, a relationship extraction unit 18, a relationship learning unit 19, an embedding representation output unit 20, and a link prediction unit 21. Each of the functional units 11 to 21 only needs to be configured in one device, as illustrated in FIG. 14, or only needs to be configured in a plurality of devices in a distributed manner.

The block diagram illustrated in FIG. 14 illustrates blocks of functional units. These functional blocks (components) are implemented by any combination of at least one of hardware or software. In addition, a method of implementing each functional block is not particularly limited. That is, each functional block only needs to be implemented by using one device that is physically or logically coupled, or only needs to be implemented by connecting two or more devices that are physically or logically separated directly or indirectly (for example, using wired or wireless connections), and using these plurality of devices. The functional block only needs to be implemented by combining software with one device or the plurality of devices described above.

Next, each functional unit of the embedding representation generation device 10 will be described. The utterance log acquisition unit 11 acquires an utterance log representing the content of an utterance of the user. The voice recognition unit 12 converts the utterance log into a text in a case where the utterance log is a voice. The text acquisition unit 13 acquires an utterance text, which is a text representing the content of an utterance of the user, based on the utterance log. The emotion acquisition unit 14 acquires emotion information representing an emotion of the user when the user utters based on a voice of the utterance or a facial expression of the user, and associates the acquired emotion information with an utterance text representing the content of the utterance.

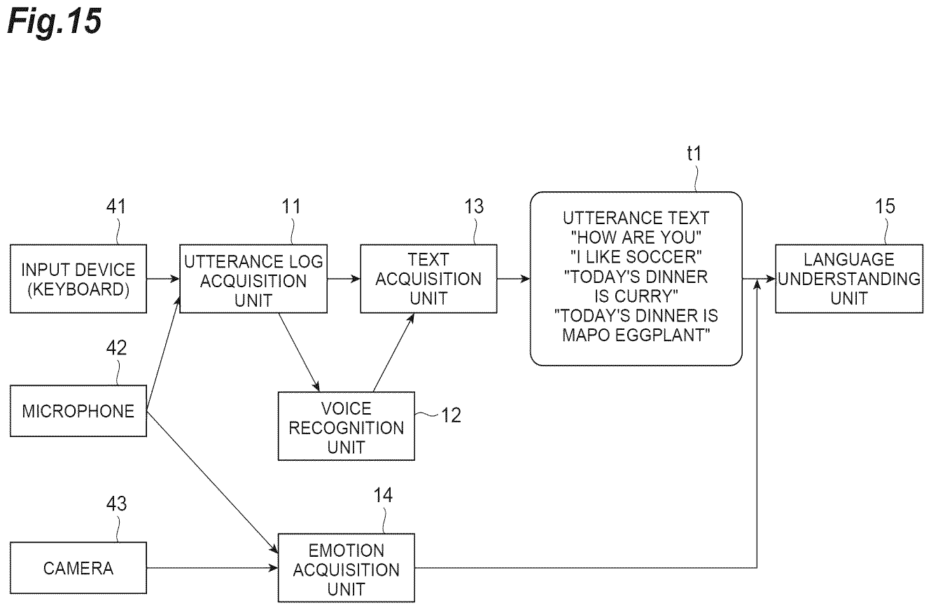

The contents of processing of the utterance log acquisition unit 11, the voice recognition unit 12, the text acquisition unit 13, and the emotion acquisition unit 14 will be specifically described with reference to FIG. 15. FIG. 15 is a diagram schematically illustrating a step of acquiring an utterance text.

The utterance log acquisition unit 11 may acquire an utterance log representing the content of the utterance of the user in an aspect of text based on the input via the input device 41 exemplified by, for example, a keyboard and a touch panel. In addition, the utterance log acquisition unit 11 may acquire an utterance log representing the content of the utterance of the user in an aspect of the voice data, for example, based on the voice input via the microphone 42.

The utterance log acquired by the utterance log acquisition unit 11 only needs to be a voice or text (chat) representing the content of the utterance of the user in a predetermined virtual space. The predetermined virtual space only needs to be, for example, a virtual space called a so-called metaverse. The utterance by the user may also be an utterance made by an avatar in a virtual space such as a metaverse, and the utterance log acquisition unit 11 may acquire an utterance log representing the utterance by the avatar in the form of voice or text.

The voice recognition unit 12 converts the voice into a text in a case where the utterance log in the aspect of the voice is acquired by the utterance log acquisition unit 11. The voice recognition unit 12 may convert an utterance log including a voice into a text by any method, and, for example, may convert a voice into a text by a well-known voice recognition technique.

The text acquisition unit 13 acquires an utterance text, which is a text representing the content of the utterance of the user, based on the utterance log. In a case where the utterance log is acquired in the aspect of the text by the utterance log acquisition unit 11, the text acquisition unit 13 acquires a text representing the utterance log as the utterance text. In addition, in a case where the utterance log is acquired in the aspect of the voice by the utterance log acquisition unit 11, the text acquisition unit 13 acquires the utterance log converted into the text by the voice recognition unit 12 as the utterance text. The text acquisition unit 13 transmits the acquired utterance text t1 to the language understanding unit 15.

The emotion acquisition unit 14 acquires emotion information representing the emotion of the user when the user utters, for example, based on the utterance voice of the user acquired via the microphone 42 or the image representing the facial expression of the user acquired via the camera 43.

The emotion acquisition unit 14 may acquire the emotion information on the user from the utterance voice by any method, and, for example, may acquire the emotion information from the utterance voice by a well-known emotion recognition technique. In addition, the emotion acquisition unit 14 may acquire the emotion information on the user from the image representing the facial expression of the user by any method, and, for example, may acquire the emotion information from the image representing the facial expression of the user by a well-known facial expression recognition technique.

In addition, the acquisition source of the emotion information is not limited to the facial expression and the utterance voice of the user, and the emotion acquisition unit 14 may acquire the emotion information from a state of the avatar when the user utters in the virtual space.

The emotion information includes, for example, types such as “joy”, “anger”, “sadness”, and “surprise”, and some predetermined types of emotions such as “pleasant” and “calm”, can be classified as positive emotions.

The emotion acquisition unit 14 associates the emotion information acquired from the facial expression, voice, and the like when the user utters with the utterance text t1 representing the content of the utterance. Therefore, the language understanding unit 15 can acquire the utterance text t1 associated with the emotion information.

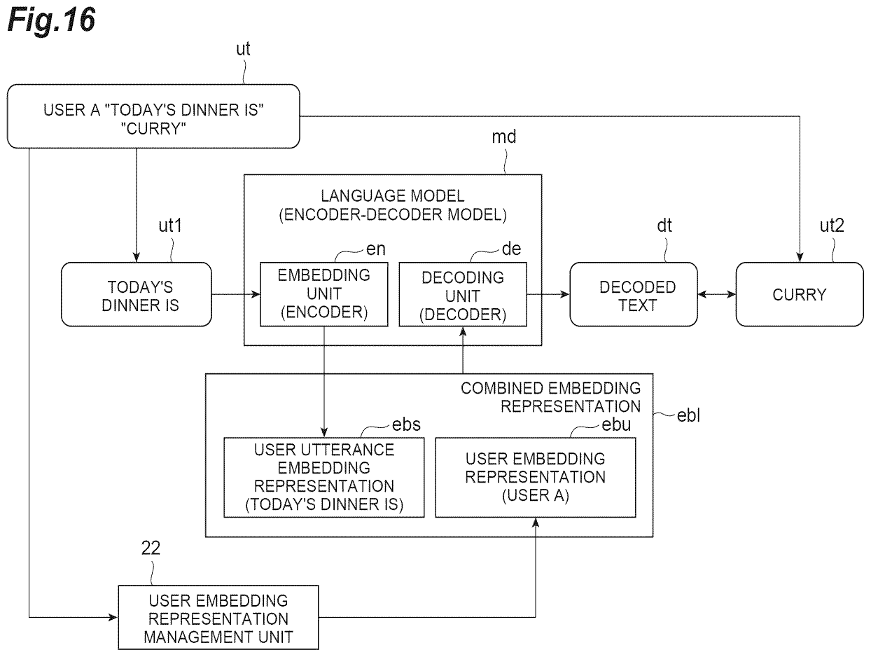

The language understanding unit 15 performs machine learning of a language model configured with an encoder-decoder model. FIG. 16 is a diagram illustrating a configuration of a language model and an example of a machine learning process of the language model. The language model md is an encoder-decoder model configured to include a neural network, and includes an embedding unit en (encoder) and a decoding unit de (decoder).

The configuration of the language model md is not limited; for example, it may be an encoder-decoder model configured with a pair of recurrent neural networks such as seq2seq, or it may be configured with a transformer such as a text-to-text transfer transformer (T5).

The embedding unit en encodes the input text and outputs an embedding representation representing a feature of the text. The decoding unit de decodes an embedding representation including at least the output from the embedding unit en, and outputs a decoded text dt. In the description of the input and output of the language model, the term “text” refers to vector data obtained by converting a text by a predetermined method, or refers to one output as vector data representing the text.

The language understanding unit 15 acquires a user utterance embedding representation output from the embedding unit en by inputting a first user utterance text representing the content of the utterance of one user among the utterance texts representing the content of the utterance of the user to the embedding unit en.

In the example illustrated in FIG. 16, the language understanding unit 15 inputs a first user utterance text ut1 (today's dinner is) of the utterance texts ut (“today's dinner is”, and “curry”) representing the content of the utterance of the user A, which is the training data for the learning of the language model md, to the embedding unit en. The language understanding unit 15 acquires a user utterance embedding representation ebs encoded and output by the embedding unit en.

Here, the language understanding unit 15 acquires the user embedding representation, which is an embedding representation of the user. For example, the embedding representation generation device 10 may further include a user embedding representation management unit 22. The user embedding representation management unit 22 may generate and manage an initial user embedding representation before learning. In addition, the user embedding representation management unit 22 may manage the user embedding representation in the learning process. The user embedding representation management unit 22 only needs to be configured as a functional unit of the embedding representation generation device 10 illustrated in FIG. 14, or only needs to be configured as a separate device.

The user embedding representation is represented by a real number vector. The initial user embedding representation only needs to be a random real number vector or a real number vector including a feature amount in which some features regarding the user are reflected. In the embedding representation generation device 10 according to the present embodiment, a method of obtaining the initial user embedding representation is not limited, and any well-known method only needs to be used.

The language understanding unit 15 generates a combined embedding representation obtained by combining the user utterance embedding representation and the user embedding representation which is an embedding representation of one user. The language understanding unit 15 may connect the user utterance embedding representation and the user embedding representation to generate a combined embedding representation. In the example illustrated in FIG. 16, the language understanding unit 15 acquires the user embedding representation ebu of the user A from the user embedding representation management unit 22, and connects the user utterance embedding representation ebs, which is the embedding representation of the first user utterance text ut1, and the user embedding representation ebu of the user A to generate a combined embedding representation eb1. The language understanding unit 15 acquires the decoded text dt decoded by the decoding unit de by inputting the combined embedding representation eb1 to the decoding unit de.

The language understanding unit 15 performs machine learning of adjusting the language model and the user embedding representation such that an error between a second user utterance text following the first user utterance text in the utterance text and the decoded text is reduced.

In the example illustrated in FIG. 16, the language understanding unit 15 adjusts the language model md and the user embedding representation ebu such that an error between the second user utterance text ut2 (curry) following the first user utterance text ut1 in the utterance text ut (“today's dinner is” and “curry”) and the decoded text dt is reduced.

The language understanding unit 15 may perform machine learning for adjusting the language model md and the user embedding representation using the utterance text associated with the emotion information representing the predetermined positive emotion. As described above, the utterance text ut can be accompanied by the emotion information representing the emotion of the user when the utterance related to the utterance text utters. In such a case, the language understanding unit 15 may perform machine learning for adjusting the language model md and the user embedding representation by using, for example, the utterance text ut associated with the emotion information representing the positive emotion such as “pleasant” and “calm” as the training data.

As described above, by using the utterance text associated with the emotion information representing the positive emotion for the machine learning, it is possible to use a combination of the first and second user utterance texts that are highly likely to be expressed when the user has the positive emotion as the training data. By performing machine learning using such training data, an embedding unit that can generate a topic embedding representation in which a suitable relationship with the topic word or the like is reflected for the user and a user embedding representation are obtained.

The language model md, which is a model including a learned neural network, can be perceived as a program that is read by or referred to a computer, causes the computer to execute predetermined processing, and causes the computer to implement predetermined functions.

That is, the learned language model md of the present embodiment is used in a computer including a CPU and a memory. Specifically, the CPU of the computer operates in accordance with instructions from the learned language model md stored in memory to perform a calculation on the input data input to the input layer of the neural network based on, for example, a learned weighting coefficient (parameter) and a response function corresponding to each layer, and to output a result (probability) from the output layer.

With reference to FIG. 14 again, the topic extraction unit 16 extracts a topic word, which is a phrase representing a topic in the utterance of the user, from the utterance text. The method applied to the extraction of the topic word is not limited, and the topic extraction unit 16 can extract the topic word by using, for example, well-known methods such as morphological analysis, text mining, and the like.

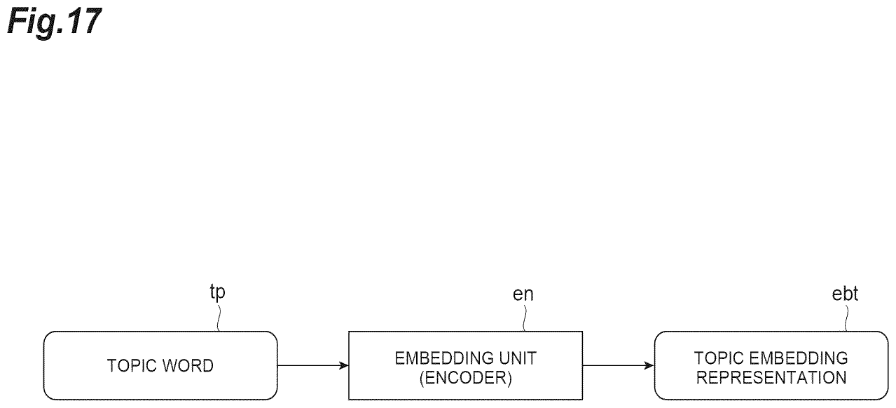

The embedding representation acquisition unit 17 inputs the topic word to the trained embedding unit, and acquires the topic embedding representation output from the embedding unit. FIG. 17 is a diagram illustrating an example of embedding representation acquisition processing using an embedding unit of a learned language model. As illustrated in FIG. 17, the embedding representation acquisition unit 17 acquires a topic embedding representation ebt by inputting a topic word tp extracted by the topic extraction unit 16 to the trained embedding unit en. The trained embedding unit en can output a suitable topic embedding representation in which the feature of the topic is appropriately reflected in response to the input of the topic word.

In addition, the embedding representation acquisition unit 17 may further acquire a place embedding representation output from the embedding unit en by inputting a place text representing a place to the trained embedding unit en. The place text only needs to be, for example, the name of the place, a description text describing the place, or the like. As a result, the place embedding representation in which the feature of the place is suitably reflected is obtained.

The relationship extraction unit 18 generates a relationship graph in which at least the user and the topic are set as nodes based on a history of the utterance (utterance log) and a history of the behavior of the user. In addition, the relationship extraction unit 18 may generate a relationship graph further including a place as a node.

The relationship extraction unit 18 extracts a relationship between nodes based on the records of the utterance, the behavior, and the like of the user, and attaches an edge based on the extracted relationship. In the present embodiment, the relationship extraction unit 18 generates a relationship graph based on a history of the utterance and a history of the behavior of the user in the predetermined virtual space.

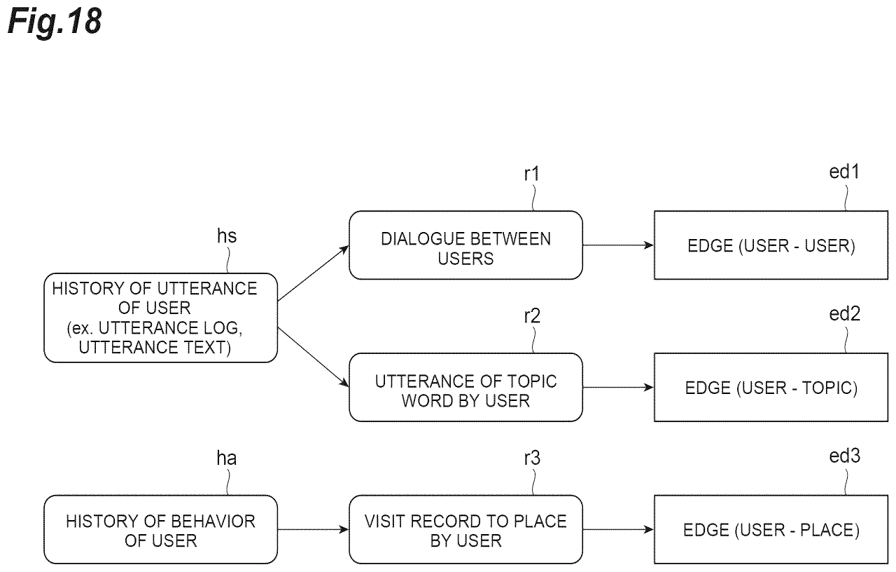

FIG. 18 is a diagram illustrating an example of acquisition of an edge for generating a relationship graph. As illustrated in FIG. 18, the relationship extraction unit 18 acquires, for example, a history of the utterance hs of the user in a virtual space such as a metaverse (an utterance log, an utterance text, and the like). The relationship extraction unit 18 extracts a dialogue record r1 between the users from the history of the utterance hs of the user, and assigns the dialogue record r1 as an edge ed1 between the nodes of the user in the relationship graph.

In addition, the relationship extraction unit 18 extracts an utterance record r2 of the topic word by the user from the history of the utterance hs of the user, and assigns the utterance record r2 as an edge ed2 that connects the node of the user and the node of the topic word.

Furthermore, the relationship extraction unit 18 acquires a history of the behavior ha of the user in the virtual space. The relationship extraction unit 18 extracts a visit record r3 to a place by the user from the history of the behavior ha of the user, and assigns the visit record r3 as an edge ed3 that connects the node of the user and the node of the place.

The relationship learning unit 19 obtains a learned embedding representation of each node by learning a graph neural network in which each of the learned user embedding representation and the topic embedding representation is set as the feature amounts of the nodes of the user and the topic in a relationship graph.

In addition, for the relationship graph further including a node of a place, the relationship learning unit 19 may obtain a learned embedding representation of each node by learning a graph neural network of the relationship graph using the place embedding representation as a feature amount of the node of a place.

Specifically, the relationship learning unit 19 associates the learned user embedding representation ebu obtained by machine learning performed by the language understanding unit 15 and the topic embedding representation ebt acquired by the embedding representation acquisition unit 17 with each node of the user and the topic of the relationship graph as feature amounts. In addition, the relationship learning unit 19 associates the place embedding representation acquired by the embedding representation acquisition unit 17 with the node of the place of the relationship graph as a feature amount.

The relationship learning unit 19 changes the feature amount and the weight of each node by performing the learning of the graph neural network of the relationship graph in which the embedding representation is set as the feature amount of each node, and obtains the learned embedding representation of each node.

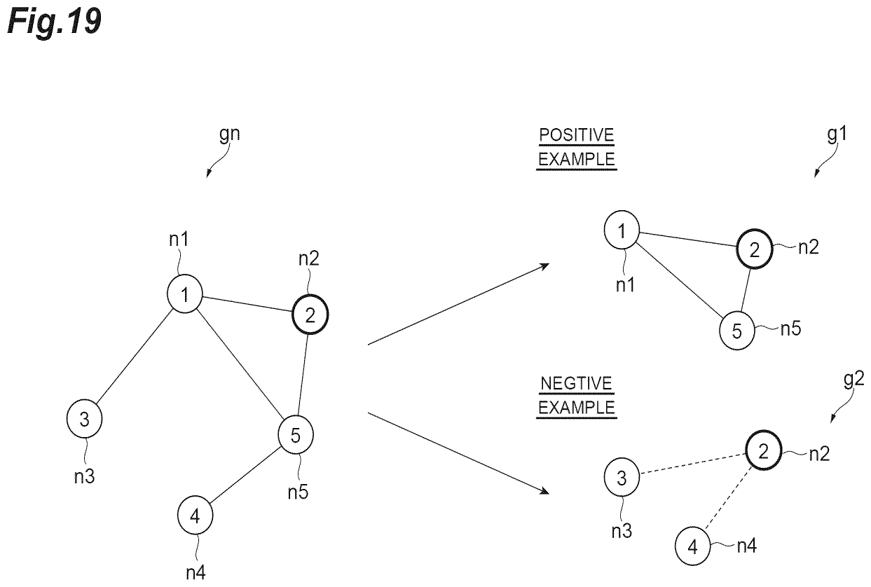

The relationship learning unit 19 can perform learning of the relationship graph by a known learning method of a graph neural network. The learning of the relationship graph will be briefly described with reference to FIG. 19. FIG. 19 is a diagram illustrating an example of a relationship graph and an example of extraction of a positive example and a negative example from the relationship graph.

A relationship graph gn illustrated in FIG. 19 includes nodes n1 to n5 corresponding to any of a user, a topic, and a place. The relationship learning unit 19 randomly samples the node of interest. In the example illustrated in FIG. 19, it is assumed that the node n2 is sampled as the node of interest.

The relationship learning unit 19 extracts a positive example graph g1 and a negative example graph g2 from the relationship graph gn. The positive example graph g1 includes the node n2 that is the node of interest and the nodes n1 and n5 connected to the node n2 by edges. The negative example graph g2 includes the node n2 that is the node of interest and the nodes n3 and n4 that are not connected to the node n2 by an edge. The negative example graph g2 does not need to include all the nodes that are not connected to the node of interest by an edge.

Hereinafter, an example of learning the relationship graph gn will be described, and since the learning process of the graph neural network is a well-known technique, the learning process will be briefly described.

First, the learning in the positive example graph g1 will be described. The relationship learning unit 19 extracts an adjacency matrix A in which the nodes included in the graph are set as rows and columns and a connection relationship by an edge with the node n2 which is a node of interest is represented as an element, based on the positive example graph g1.

In addition, the relationship learning unit 19 extracts a diagonal matrix I in which the nodes included in the graph are set as rows and columns and a self-loop of the node is represented as an element. When a real number vector representing the feature amount of the node is denoted by a node feature amount X, the feature amount of each node is represented by the following expression as a sum (convolution) of the feature amount of the node having a connection relationship represented by the adjacency matrix A and the feature amount of the self-node represented by the diagonal matrix I.

$$( A + I ) \cdot X$$

The relationship learning unit 19 multiplies the feature amount of each convolved node by a weight W and further inputs the result to an activation function f to obtain an output H, as represented by the following expression.

$$H ( positive example ) = f ( ( A + I ) \cdot X \cdot W )$$

The relationship learning unit 19 learns the weight and the feature amount such that the output H (positive example) obtained based on the positive example graph g1 is 1.

The relationship learning unit 19 similarly obtains an output H (negative example) based on the negative example graph g2. The relationship learning unit 19 learns the weight and the feature amount such that the output H (negative example) obtained based on the negative example graph g2 is 0.

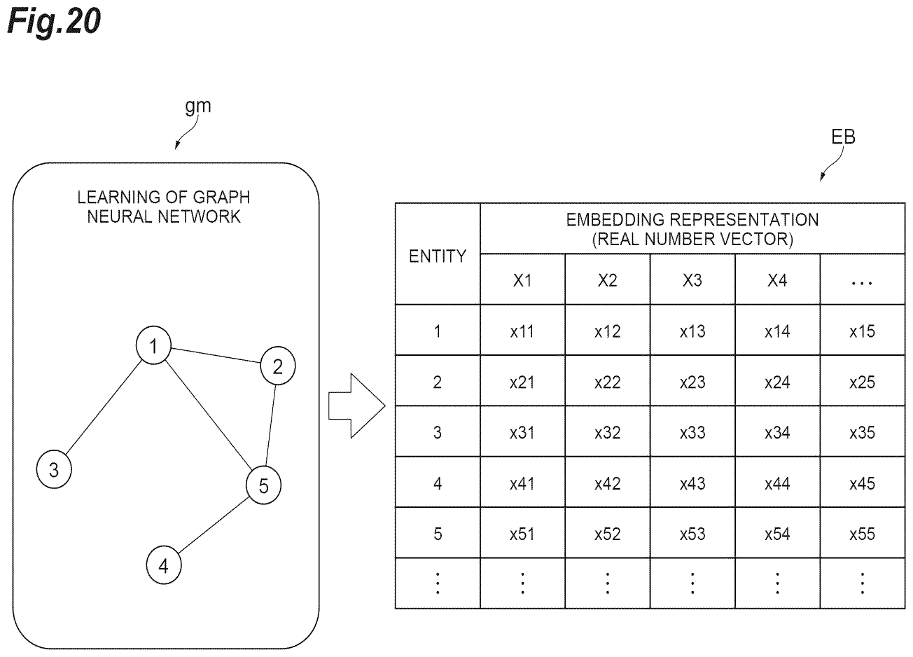

With reference to FIG. 14 again, the embedding representation output unit 20 outputs the embedding representation of each node that is subjected to the learning by the relationship learning unit 19. FIG. 20 is a diagram illustrating an example of an embedding representation of each entity obtained by learning a graph neural network constituting a relationship graph. As illustrated in FIG. 20, the embedding representation output unit 20 outputs an embedding representations EB of the entities 1, 2, 3, 4, 5, . . . corresponding to each node of the relationship graph gn by the learning gm of the graph neural network for the relationship graph gn by the relationship learning unit 19.

Since the embedding representation of each node obtained in this manner is a real number vector in which the feature of each entity corresponding to each node is suitably reflected and the relationship between the entities is reflected, it is possible to calculate the distance between the entities. Therefore, when each node in the relationship graph corresponds to entities of different types such as a user, a topic, and a place, it is possible to calculate the distance between the entities of different types.

An aspect of outputting the embedding representation by the embedding representation output unit 20 is not limited, and only needs to be the storage by predetermined storage means, the transmission to a predetermined device, the display on a predetermined display device, or the like.

With reference to FIG. 14 again, the link prediction unit 21 calculates the distance between nodes based on the embedding representation of each learned node, and calculates link prediction information indicating the possibility that an edge is attached between each node based on the calculated distance between nodes.

Specifically, for example, the link prediction unit 21 determines whether or not the distance between the nodes calculated as the distance between the real number vectors is equal to or less than a given threshold value. In a case where it is determined that the distance between the nodes is equal to or less than the threshold value, the link prediction unit 21 outputs link prediction information indicating that an edge is predicted to be present between the nodes.

As described above, the embedding representation represented by the real number vector, in which the distance between the entities of different types can be calculated by the learning gm of the graph neural network related to the relationship graph gn, is obtained, and thus the link prediction information for evaluating the possibility that the edge is drawn between each node of the graph is calculated. Therefore, it is possible to predict that there is a certain degree or more of relationship between the entities corresponding to each node.

In addition, the link prediction unit 21 outputs information indicating each node in which the distance between the nodes is equal to or less than the threshold value as the link prediction information, based on the given threshold value related to the distance between the nodes.

Specifically, for example, the link prediction unit 21 determines whether or not the distance between the nodes calculated as the distance between the real number vectors is equal to or less than a given threshold value, and outputs information indicating the entity corresponding to the node in which the distance is determined to be equal to or less than the threshold value as the link prediction information. In a case where at least one of the entities corresponding to the node in which the distance is determined to be equal to or less than the threshold value is the user, information indicating the other entity only needs to be provided to the user as recommendation information.

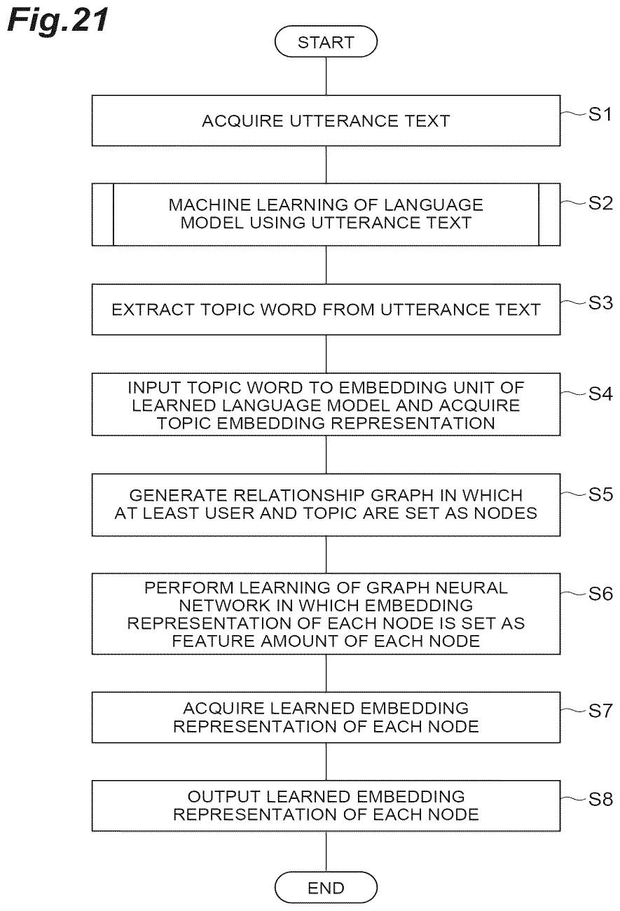

FIG. 21 is a flowchart illustrating the processing contents of an embedding representation generation method in the embedding representation generation device 10.

In step S1, the text acquisition unit 13 acquires an utterance text which is a text representing the content of an utterance of the user based on the utterance log.

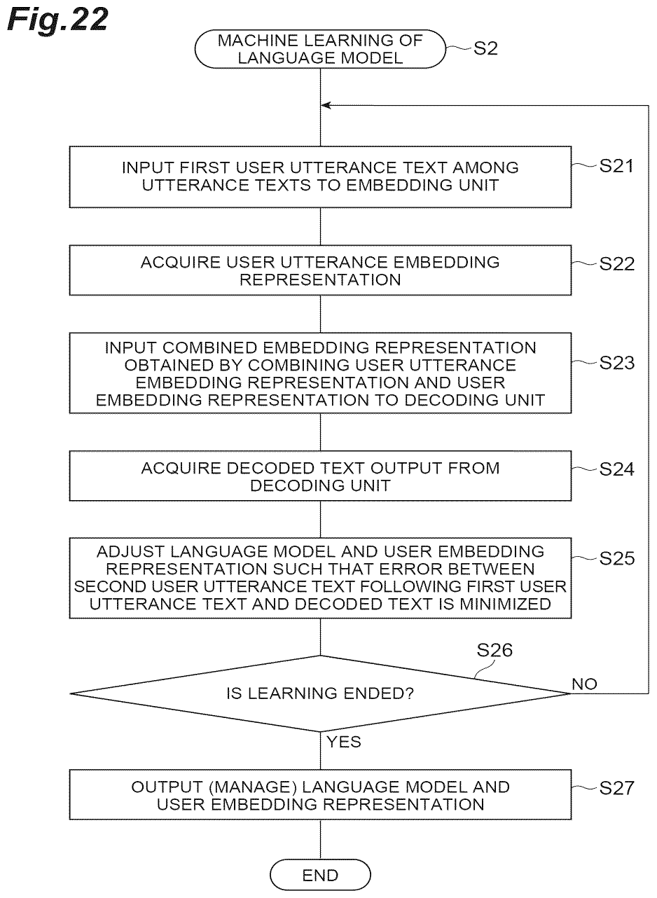

In step S2, the language understanding unit 15 performs machine learning of a language model configured with an encoder-decoder model. The processing contents of step S2 will be described with reference to FIG. 22.

FIG. 22 is a flowchart illustrating the processing contents of machine learning of the language model. In step S21, the language understanding unit 15 inputs a first user utterance text representing the content of the utterance of one user among the utterance texts to the embedding unit en.

In step S22, the language understanding unit 15 acquires the user utterance embedding representation ebs encoded and output by the embedding unit en.

In step S23, the language understanding unit 15 generates a combined embedding representation eb1 by combining the user utterance embedding representation and the user embedding representation of the user. The language understanding unit 15 then inputs the combined embedding representation eb1 to the decoding unit de.

In step S24, the language understanding unit 15 acquires the decoded text dt decoded by the decoding unit de.

In step S25, the language understanding unit 15 performs machine learning of adjusting the language model and the user embedding representation such that an error between the second user utterance text following the first user utterance text in the utterance text and the decoded text is reduced.

In step S26, the language understanding unit 15 determines whether or not to end the machine learning of the language model. In a case where it is determined that the machine learning of the language model is ended, the processing proceeds to step S27. On the other hand, in a case where it is determined that the machine learning of the language model is not ended, the processing of steps S21 to S25 is repeated by using the utterance text (first and second user utterance texts) as the training data.

In step S27, the language understanding unit 15 outputs the learned language model and the user embedding representation. For example, the language understanding unit 15 may store a learned language model in predetermined storage means. In addition, the language understanding unit 15 may store the learned user embedding representation in predetermined storage means, or may manage the user embedding representation in the user embedding representation management unit 22.

With reference to FIG. 21 again, in step S3, the topic extraction unit 16 extracts a topic word, which is a phrase representing a topic in the utterance of the user, from the utterance text.

In step S4, the embedding representation acquisition unit 17 inputs the topic word to the trained embedding unit en, and acquires the topic embedding representation output from the embedding unit en. Here, the embedding representation acquisition unit 17 may further acquire the place embedding representation output from the embedding unit en by inputting the place text representing the place to the trained embedding unit en.

In step S5, the relationship extraction unit 18 generates a relationship graph in which at least the user and the topic are set as nodes based on a history of the utterance (utterance log) and a history of the behavior of the user. In addition, the relationship extraction unit 18 may generate a relationship graph further including a place as a node.

In step S6, the relationship learning unit 19 performs learning of a graph neural network in which each of the learned user embedding representation and the topic embedding representation is set as the feature amounts of the nodes of the user and the topic in the relationship graph. The relationship graph used for learning may further include a place as a node, and a place embedding representation only needs to be a feature amount of the node of the place.

In step S7, the relationship learning unit 19 changes the feature amount and the weight of each node by performing the learning of the graph neural network of the relationship graph in which the embedding representation is set as the feature amount of each node, and obtains the learned embedding representation of each node.

In step S8, the embedding representation output unit 20 outputs the embedding representation of each node subjected to the learning by the relationship learning unit 19.

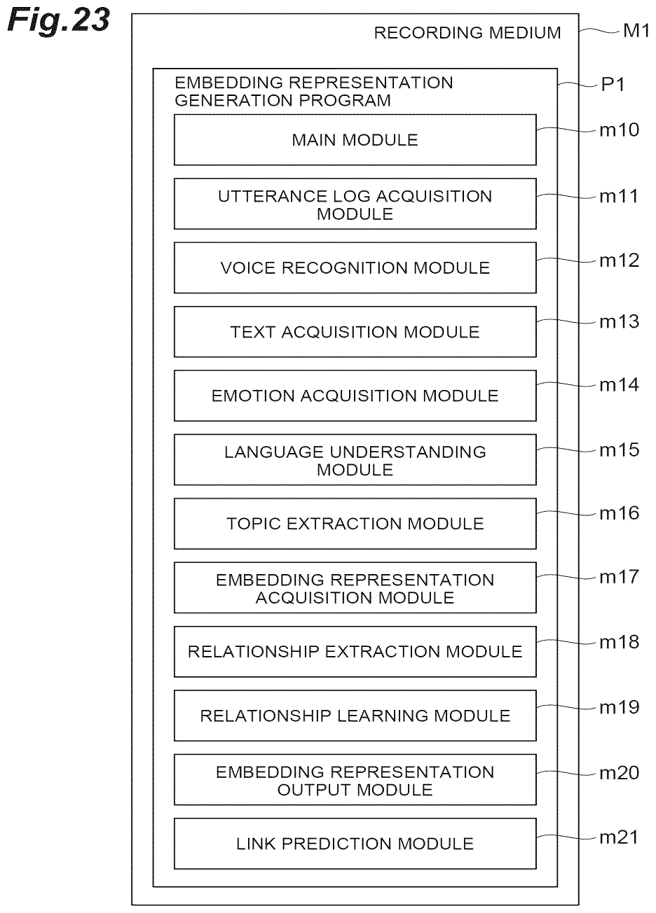

Next, an embedding representation generation program for causing the computer to function as the embedding representation generation device 10 according to the present embodiment will be described with reference to FIG. 23. FIG. 23 is a diagram illustrating a configuration of an embedding representation generation program. The embedding representation generation program P1 is configured to include a main module m10 that integrally controls the embedding representation generation processing in the embedding representation generation device 10, an utterance log acquisition module m11, a voice recognition module m12, a text acquisition module m13, an emotion acquisition module m14, a language understanding module m15, a topic extraction module m16, an embedding representation acquisition module m17, a relationship extraction module m18, a relationship learning module m19, an embedding representation output module m20, and a link prediction module m21. Each function for each of the functional units 11 to 21 is implemented by each of the modules m11 to m21.

The embedding representation generation program P1 only needs to be in an aspect that is transmitted via a transmission medium such as a communication line, or only needs to be in an aspect that is stored in a recording medium M1, as illustrated in FIG. 23.

According to the embedding representation generation device 10, the embedding representation generation method, and the embedding representation generation program P1 of the present embodiment described above, the language model configured with the encoder-decoder model inputs the combined embedding representation obtained by combining the user utterance embedding representation obtained by inputting the first user utterance text into the embedding unit and the user embedding representation and the user embedding representation to the decoding unit, using a pair of the first user utterance text and the second user utterance text as the training data, and machine learning is performed on the language model and the user embedding representation such that the error between the decoded text output from the decoding unit and the second user utterance text is reduced. Therefore, the embedding unit (encoder) that outputs a suitable topic embedding representation in response to the input of the topic word is obtained, and the user embedding representation in which the feature of the user is suitably reflected is obtained. The relationship graph in which the user and the topic are set as nodes and the edge is drawn between the nodes based on a history of the utterance and the behavior of the user is generated, and a learned topic embedding representation and a user embedding representation in which the topic word and the feature of the user are suitably reflected are obtained by learning the graph neural network in which each of the topic embedding representation obtained by inputting the topic word to the embedding unit and the learned user embedding representation is set as the feature amount of the topic word and the user. Since the relationship between the entities is reflected in the obtained topic embedding representation and user embedding representation, it is possible to calculate the distance between the user and the topic.

The invention according to the present disclosure is understood as follows, for example.

A parameter acquisition system according to a first aspect of the present disclosure is a parameter acquisition system that acquires a parameter set for a character to be activated in a virtual space, the system including a topic acquisition unit that acquires at least one topic in which closeness of a distance between a user embedding representation, which is an embedding representation in which a user is represented by a real number vector, and a topic embedding representation, which is an embedding representation in which a topic is represented by a real number vector, corresponds to a predetermined condition, a hobby acquisition unit that acquires a hobby corresponding to a topic acquired by the topic acquisition unit based on correspondence information representing a correspondence relationship between the topic and the hobby, and a setting information output unit that outputs a hobby acquired by the hobby acquisition unit as hobby information for setting the parameter of the character corresponding to the user.

According to the above aspect, since the distance between the user and the topic can be calculated based on the user embedding representation and the topic embedding representation in which each of the features of the user and the topic is represented, the topic in which the closeness of the distance to the user corresponds to a predetermined condition can be acquired. The hobby corresponding to the topic is acquired based on the correspondence information. Therefore, the acquired hobby has a certain degree or more of closeness to the user.

The acquired hobby is output as the hobby information, so that the hobby information can be applied to a parameter for setting the character of the user.

In a parameter acquisition system according to a second aspect, in the parameter acquisition system according to the first aspect, the hobby acquisition unit may refer to a thesaurus in which a relationship between a plurality of words including at least a hobby word representing a hobby and a topic word representing a topic is defined as the correspondence information, and may acquire a hobby corresponding to the hobby word associated with the topic word corresponding to the topic acquired by the topic acquisition unit.

According to the above aspect, with reference to the correspondence information including the thesaurus defining the relationship between the words representing the hobby and the topic, the corresponding hobby word is extracted based on the topic word representing the topic having a close relationship with the user. Therefore, the hobby represented by the hobby word can be output as hobby information having a close relationship with the user.

In a parameter acquisition system according to a third aspect, in the parameter acquisition system according to the first aspect, the hobby acquisition unit may refer to a given hobby list including a plurality of hobby words representing hobbies, calculate a degree of similarity between each of topic words representing the topic acquired by the topic acquisition unit and a hobby word included in the hobby list as the correspondence information, and acquire a hobby corresponding to a hobby word of which the calculated degree of similarity is equal to or greater than a given threshold value.

According to the above aspect, the hobby represented by the hobby word having a high degree of similarity to the topic word representing the topic having a close relationship with the user is acquired. Therefore, the hobby having a close relationship with the user can be output as hobby information.

In a parameter acquisition system according to a fourth aspect, in the parameter acquisition system according to the third aspect, the hobby acquisition unit may calculate the degree of similarity between the topic word and the hobby word using Word2Vec.

According to the above aspect, the degree of similarity between the hobby word included in the hobby list and the topic word is calculated with high accuracy.

In a parameter acquisition system according to a fifth aspect, in the parameter acquisition system according to any one of the first to fourth aspects, the system may further include an attribute acquisition unit that acquires attribute information associated with the hobby acquired by the hobby acquisition unit with reference to a given attribute list in which the hobby and attribute information on a person are associated with each other, in which the setting information output unit may output the attribute information acquired by the attribute acquisition unit as information for setting a parameter of the character corresponding to the user.

According to the above aspect, since the attribute information associated with the hobby acquired with reference to the attribute list is acquired, the attribute information corresponding to the user can be output as the information for setting the parameter of the character. Therefore, the attribute information can be set as a parameter of the character in addition to the hobby.

In a parameter acquisition system according to a sixth aspect, in the parameter acquisition system according to any one of the first to fifth aspects, the topic acquisition unit may acquire a predetermined number of topics in which the closeness of the distance between the user embedding representation of the user and the topic embedding representation of the topic is high level, or may acquire a topic in which the distance between the user embedding representation of the user and the topic embedding representation of the topic is equal to or less than a predetermined degree.

According to the above aspect, the topic having a suitable closeness at a distance to the user is acquired. It is possible to acquire hobby information suitable as a parameter to be set for the character of the user.

In a parameter acquisition system according to a seventh aspect, in the parameter acquisition system according to any one of the first to sixth aspects, the system may further include an embedding representation input unit that acquires the user embedding representation and the topic embedding representation from an embedding representation generation device generating at least embedding representations of a user and a topic, in which the embedding representation generation device may include a language understanding unit that learns a language model configured with an encoder-decoder model including an embedding unit and a decoding unit, in which the embedding unit outputs an embedding representation representing a feature of an input text, the decoding unit decodes an embedding representation including at least an output from the embedding unit, a user utterance embedding representation output from the embedding unit is acquired by inputting a first user utterance text representing a content of an utterance of one user among utterance texts representing a content of an utterance of the user to the embedding unit, a decoded text output from the decoding unit is acquired by inputting a combined embedding representation obtained by combining the user utterance embedding representation and the user embedding representation of the one user to the decoding unit, and machine learning of adjusting the language model and the user embedding representation is performed such that an error between a second user utterance text following the first user utterance text in the utterance text and the decoded text is reduced, and the user embedding representation is an initial user embedding representation before learning or a user embedding representation in a learning process, a topic extraction unit that extracts a topic word, which is a phrase representing a topic in the utterance of the user, from the utterance text, an embedding representation acquisition unit that inputs the topic word to the trained embedding unit, and acquires a topic embedding representation output from the embedding unit, a relationship extraction unit that generates a relationship graph, which is a graph in which at least a user and a topic are set as nodes, a dialogue record between the users is set as an edge connecting the users, and an utterance record of the topic word of the user is set as an edge connecting the user and the topic, based on a history of an utterance and a history of behavior of the user, a relationship learning unit that obtains a learned embedding representation of each node by learning a graph neural network in which the learned user embedding representation and the topic embedding representation are each set as a feature amount of the node of the user and the node of the topic in the relationship graph, and an embedding representation output unit that outputs the learned embedding representation of each node to the embedding representation input unit.

According to the above aspect, the language model configured with the encoder-decoder model inputs the combined embedding representation obtained by combining the user utterance embedding representation obtained by inputting the first user utterance text into the embedding unit and the user embedding representation and the user embedding representation to the decoding unit, using a pair of the first user utterance text and the second user utterance text as the training data, and machine learning is performed on the language model and the user embedding representation such that the error between the decoded text output from the decoding unit and the second user utterance text is reduced. Therefore, the embedding unit (encoder) that outputs a suitable topic embedding representation in response to the input of the topic word is obtained, and the user embedding representation in which the feature of the user is suitably reflected is obtained. The relationship graph in which the user and the topic are set as nodes and the edge is drawn between the nodes based on a history of the utterance and the behavior of the user is generated, and a learned topic embedding representation and a user embedding representation in which the topic word and the feature of the user are suitably reflected are obtained by learning the graph neural network in which each of the topic embedding representation obtained by inputting the topic word to the embedding unit and the learned user embedding representation is set as the feature amount of the topic word and the user. Since the obtained topic embedding representation and user embedding representation reflect the relationship between the entities, it is possible and suitable to calculate the distance between the user and the topic.

In addition, when the embedding representation generation device in the parameter acquisition system according to the seventh aspect is regarded as the embedding representation generation device according to the first aspect, the embedding representation generation device according to the first aspect has the following other aspects.

In an embedding representation generation device according to a second aspect, in the embedding representation generation device according to the first aspect, the device may further include an emotion acquisition unit that acquires emotion information representing an emotion of the user when the user utters, based on a voice of the utterance or a facial expression of the user, and associates the acquired emotion information with the utterance text representing a content of the utterance, in which the language understanding unit may perform machine learning of adjusting the language model and the user embedding representation, using the utterance text with which the emotion information representing a predetermined positive emotion is associated.

According to the above aspect, the utterance text representing the utterance uttered by the user when there is a high possibility that the user has a positive emotion is used for machine learning. Therefore, the combination of the first and second user utterance texts constituting the training data is a combination that is highly likely to be expressed when the user has a positive emotion. By performing machine learning using such training data, it is possible to obtain an embedding unit that can generate a topic embedding representation in which a suitable relationship with the topic word is reflected for the user, and a user embedding representation.

In an embedding representation generation device according to a third aspect, in the embedding representation generation device according to the first or second aspect, the embedding representation acquisition unit may further acquire a place embedding representation output from the embedding unit by inputting a place text representing a place to the trained embedding unit, the relationship extraction unit may generate a relationship graph, which is a graph in which at least a user, a topic, and a place are set as nodes, a dialogue record between the users is set as an edge connecting the users, an utterance record of a topic word of the user is set as an edge connecting the user and the topic, and a visit record of the user to the place is set as an edge connecting the user and the place, based on a history of the utterance and a history of the behavior of the user, and the relationship learning unit may obtain a learned embedding representation of each node by learning a graph neural network in which each of the learned user embedding representation, the topic embedding representation, and the place embedding representation is set as a feature amount of the nodes of the user, the topic, and the place in the relationship graph.

According to the above aspect, by inputting the place text to the embedding unit of the learned language model, the place embedding representation in which the feature of the place is suitably reflected is obtained. The relationship graph in which a user, a topic, and a place are set as nodes and the edge is drawn between the nodes based on a history of the utterance and the behavior of the user is generated, and a learned topic embedding representation, a place embedding representation, and a user embedding representation in which the features of the topic word, the place, and the user are suitably reflected are obtained by learning a graph neural network in which each of the topic embedding representation, the place embedding representation, and the learned user embedding representation is set as a feature amount of the topic word, the place, and the user. Since the obtained topic embedding representation, the place embedding representation, and the user embedding representation reflect the relationship between the entities, it is possible to calculate the distance between the user, the topic, and the place.

In an embedding representation generation device according to a fourth aspect, in the embedding representation generation device according to any one of the first to third aspects, the device may further include a link prediction unit that calculates a distance between the nodes based on the embedding representation of each learned node, and calculates link prediction information indicating the possibility that an edge is attached between each node based on the calculated distance between the nodes.

According to the above aspect, the embedding representation represented by the real number vector, in which the distance between the entities of different types can be calculated by the learning of the graph neural network related to the relationship graph, is obtained, and thus the link prediction information for evaluating the possibility that the edge is drawn between each node of the graph is calculated. Therefore, it is possible to predict that there is a certain degree or more of relationship between the entities corresponding to each node.

In an embedding representation generation device according to a fifth aspect, in the embedding representation generation device according to the fourth aspect, the link prediction unit may output, as the link prediction information, information indicating each node in which a distance between the nodes is equal to or less than a threshold value based on a given threshold value related to the distance between the nodes.

According to the above aspect, it is possible to obtain the information related to the entity having a relationship of a predetermined degree or more based on the information indicating the node in which the distance between the nodes is equal to or less than the given threshold value.

In an embedding representation generation device according to a sixth aspect, in the embedding representation generation device according to any one of the first to fifth aspects, the utterance text only needs to be acquired based on an utterance log of a voice or text representing the content of the utterance of the user in a predetermined virtual space.

According to the above aspect, in the virtual space, the voice or text representing the utterance of the user can be easily acquired, so that the acquisition of the utterance text is facilitated.

In an embedding representation generation device according to a seventh aspect, in the embedding representation generation device according to any one of the first to sixth aspects, the relationship extraction unit may generate the relationship graph based on a history of the utterance and a history of the behavior of the user in the predetermined virtual space.

According to the above aspect, in the virtual space, the history of the utterance and the history of the behavior of the user can be easily acquired, so that the relationship graph can be easily generated.

The present disclosure has been described in detail above, but it is clear to those skilled in the art that the present disclosure is not limited to the embodiment described in the present specification. The present disclosure can be implemented in modified and changed aspects without departing from the gist and scope of the present invention as defined by the description of the claims. Therefore, the description of the present specification is for illustrative purposes, and is not intended to limit the present disclosure in any way.

The notification of the information is not limited to the aspect/embodiment described in the present disclosure, and other methods only need to be used. For example, the information notification only needs to be performed by physical layer signaling (for example, downlink control information (DCI), uplink control information (UCI)), upper layer signaling (for example, radio resource control (RRC) signaling, medium access control (MAC) signaling, notification information (master information block (MIB), system information block (SIB))), other signals, or a combination thereof. In addition, the RRC signaling only needs to be called an RRC message, and only needs to be, for example, an RRC connection setup message, an RRC connection reconfiguration message, and the like.

Each aspect/embodiment described in the specification only needs to be applied to a system using Long Term Evolution (LTE), LTE-Advanced (LTE-A), SUPER 3G, IMT-Advanced, 4G, 5G, Future Radio Access (FRA), W-CDMA (Registered trademark), GSM (registered trademark), CDMA2000, Ultra Mobile Broadband (UMB), IEEE 802. 11 (Wi-Fi), IEEE 802. 16 (WiMAX), IEEE 802. 20, Ultra-Wide Band (UWB), Bluetooth (registered trademark), a system using another appropriate system, and/or a next-generation system extended based on the above system. In addition, a plurality of systems only need to be combined (for example, a combination of at least one of LTE or LTE-A and 5G) and applied.

Processing procedures, sequences, flowcharts, or the like of each aspect/embodiment described in the specification may change orders as long as there is no inconsistency. For example, for the method described in the specification, elements of various steps are presented in an exemplary order, and the order is not limited to the presented specific order.

The specific operation that is performed by a base station in the present disclosure may be performed by an upper node in some cases. In the network including one or a plurality of network nodes having a base station, it is clear that various operations performed for communication with a terminal may be performed by at least one of the base station or another network nodes other than the base station (for example, MME or S-GW is considered, but the present invention is not limited thereto). In the above, a case where the other network node other than the base station is one has been illustrated, and a combination of a plurality of other network nodes (for example, MME and S-GW) only needs to be used.

The information or the like (refer to the section of “information and signal”) may be output from the upper layer (or the lower layer) to the lower layer (or the upper layer). The information and the like only needs to be input and output through a plurality of network nodes.

The input and output information or the like only needs to be stored in a specific place (for example, a memory) or only needs to be managed using a management table. The input and output information or the like may be overwritten, updated, or added. The output information and the like only need to be deleted. The input information and the like only need to be transmitted to another device.

The determination only needs to be performed using a value represented by 1 bit (0 or 1), only needs to be performed using a truth value (Boolean: true or false), or only needs to be performed through comparison with numerical values (for example, comparison with a predetermined value).

Each aspect/embodiment described in the present disclosure only needs to be used alone, in combination, or switched with each other in execution. In addition, notification of predetermined information (for example, notification of “X”) is not limited to being explicitly performed, and only needs to be performed implicitly (for example, the notification of the predetermined information is not performed).

The software should be broadly construed to mean instructions, instruction sets, codes, code segments, program codes, programs, sub-programs, software modules, applications, software applications, software packages, routines, sub-routines, objects, executable files, execution threads, procedures, functions, and the like, regardless of whether the software is referred to as software, firmware, middleware, microcode, or a hardware description language, or is called by other names.

In addition, the software, the instructions, and the like only need to be transmitted and received through a transmission medium. For example, in a case where the software is transmitted from a website, a server, or another remote source using a wired technology, such as a coaxial cable, a fiber optic cable, a twisted pair and Digital Subscriber Line (DSL), and/or a wireless technology, such as infrared, wireless, or microwave, the wired and/or wireless technologies are included in a definition of the transmission medium.

The information, the signal, or the like described in the present disclosure only need to be represented by using any of various different technologies. For example, the data, the instruction, the instruction, the information, the signal, the bit, the symbol, the chip, or the like, which only need to be referred to throughout the above description, only need to be represented using a voltage, a current, an electromagnetic wave, a magnetic field or a magnetic particle, a photo field or a photon, or a random combination thereof.

Terms described in the present disclosure and/or terms necessary for understanding the present specification only need to be replaced with terms having the same or similar meanings.

The terms “system” and “network” used in the specification are used interchangeably.

In addition, information, parameters, and the like described in the specification only need to be represented by absolute values, only need to be represented by relative values from the predetermined values, or only need to be represented by other relevant information. For example, a radio resource only needs to be indicated by an index.

The names used for the above-described parameters are not limited in any way. Furthermore, the mathematical expression or the like using these parameters may be different from those explicitly disclosed in the present disclosure. Various channels (for example, PUCCH, PDCCH, and the like) and information elements can be identified by any suitable names, and various names assigned to these various channels and information elements are not limited in any way.

The term “determining” used in the present disclosure may include a wide variety of operations. The “determining” may include, for example, regarding judging, calculating, computing, processing, deriving, investigating, looking up, search, inquiry (for example, search in a table, a database or another data structure), and ascertaining as “determining”. In addition, the “determining” may include regarding receiving (for example, receiving information), transmitting (for example, transmitting information), input, output, and accessing (for example, accessing data in a memory) as “determining”. In addition, the “determining” may include regarding resolving, selecting, choosing, establishing, comparing, and the like as “determining”. That is, the “determining” may include regarding that any operation is “determined”. In addition, “determining” only needs to be interpreted as “assuming,” “expecting,” “considering,” or the like.

A description “based on” used in the present disclosure does not mean “based only on” unless otherwise specified. In other words, the phrase “based on” means both “based only on” and “based at least on”.

In a case where the terms “first”, “second”, and the like are used in the present specification, any reference to the elements does not generally limit the amount or order of the elements. These terms may be used in the present specification as a convenient method of distinguishing between two or more elements. Therefore, the reference to the first and second elements does not mean that only two elements may be employed thereto, or that the first element needs to precede the second element in some way.

As long as “include”, “including”, and variations thereof are used in the specification or claims, the terms are intended to be comprehensive, similar to a term “comprising”. Furthermore, it is intended that a term “or” used in the specification or the claims is not an exclusive OR.

In the present disclosure, for example, in a case in which an article is added by translation, such as “a”, “an”, and “the” in English, the present disclosure may include that a noun following these articles is in plural form.

In the present disclosure, the phrase “A and B are different” may mean that “A and B are different from each other”. The phrase may mean that “A and B are each different from C”. The terms “separated”, “coupled”, and the like only need to be interpreted in the same manner as “different”.

### REFERENCE SIGNS LIST

1: parameter acquisition system
10: embedding representation generation device
11: utterance log acquisition unit
12: voice recognition unit
13: text acquisition unit
14: emotion acquisition unit
15: language understanding unit
16: topic extraction unit
17: embedding representation acquisition unit
18: relationship extraction unit
19: relationship learning unit
20: embedding representation output unit
21: link prediction unit
22: embedding representation management unit
30: parameter acquisition device
31: embedding representation input unit
32: topic acquisition unit
33: hobby acquisition unit
34: attribute acquisition unit
35: setting information output unit
41: input device
42: microphone
43: camera
M1: recording medium
m10: main module
m11: utterance log acquisition module
m12: voice recognition module
m13: text acquisition module
m14: emotion acquisition module
m15: language understanding module
m16: topic extraction module
m17: embedding representation acquisition module
m18: relationship extraction module
m19: relationship learning module
m20: embedding representation output module
m21: link prediction module
M3: recording medium
m30: main module
m31: embedding representation input module
m32: topic acquisition module
m33: hobby acquisition module
m34: attribute acquisition module
m35: setting information output module
P1: embedding representation generation program
P3: parameter acquisition program

1. A parameter acquisition system that acquires a parameter set for a character to be activated in a virtual space, the system comprising:
a topic acquisition unit that acquires at least one topic in which closeness of a distance between a user embedding representation, which is an embedding representation in which a user is represented by a real number vector, and a topic embedding representation, which is an embedding representation in which a topic is represented by a real number vector, corresponds to a predetermined condition;
a hobby acquisition unit that acquires a hobby corresponding to a topic acquired by the topic acquisition unit based on correspondence information representing a correspondence relationship between the topic and the hobby; and
a setting information output unit that outputs a hobby acquired by the hobby acquisition unit as hobby information for setting the parameter of the character corresponding to the user.

2. The parameter acquisition system according to claim 1, wherein
the hobby acquisition unit refers to a thesaurus in which a relationship between a plurality of words including at least a hobby word representing a hobby and a topic word representing a topic is defined as the correspondence information, and acquires a hobby corresponding to the hobby word associated with the topic word corresponding to the topic acquired by the topic acquisition unit.

3. The parameter acquisition system according to claim 1, wherein
the hobby acquisition unit refers to a given hobby list including a plurality of hobby words representing hobbies, calculates a degree of similarity between each of topic words representing the topic acquired by the topic acquisition unit and a hobby word included in the hobby list as the correspondence information, and acquires a hobby corresponding to a hobby word of which the calculated degree of similarity is equal to or greater than a given threshold value.

4. The parameter acquisition system according to claim 3, wherein
the hobby acquisition unit calculates the degree of similarity between the topic word and the hobby word using Word2Vec.

5. The parameter acquisition system according to claim 1, further comprising:
an attribute acquisition unit that acquires attribute information associated with the hobby acquired by the hobby acquisition unit with reference to a given attribute list in which the hobby and attribute information on a person are associated with each other, wherein
the setting information output unit outputs the attribute information acquired by the attribute acquisition unit as information for setting a parameter of the character corresponding to the user.

6. The parameter acquisition system according to claim 1, wherein
the topic acquisition unit
acquires a predetermined number of topics in which the closeness of the distance between the user embedding representation of the user and the topic embedding representation of the topic is high level, or
acquires a topic in which the distance between the user embedding representation of the user and the topic embedding representation of the topic is equal to or less than a predetermined degree.

7. The parameter acquisition system according to claim 1, further comprising:
an embedding representation input unit that acquires the user embedding representation and the topic embedding representation from an embedding representation generation device generating at least embedding representations of a user and a topic, wherein
the embedding representation generation device includes
a language understanding unit that learns a language model configured with an encoder-decoder model including an embedding unit and a decoding unit, in which
the embedding unit outputs an embedding representation representing a feature of an input text,
the decoding unit decodes an embedding representation including at least an output from the embedding unit,
a user utterance embedding representation output from the embedding unit is acquired by inputting a first user utterance text representing a content of an utterance of one user among utterance texts representing a content of an utterance of the user to the embedding unit, a decoded text output from the decoding unit is acquired by inputting a combined embedding representation obtained by combining the user utterance embedding representation and the user embedding representation of the one user to the decoding unit, and machine learning of adjusting the language model and the user embedding representation is performed such that an error between a second user utterance text following the first user utterance text in the utterance text and the decoded text is reduced, and
the user embedding representation is an initial user embedding representation before learning or a user embedding representation in a learning process,
a topic extraction unit that extracts a topic word, which is a phrase representing a topic in the utterance of the user, from the utterance text,
an embedding representation acquisition unit that inputs the topic word to the trained embedding unit, and acquires a topic embedding representation output from the embedding unit,
a relationship extraction unit that generates a relationship graph, which is a graph in which at least a user and a topic are set as nodes, a dialogue record between the users is set as an edge connecting the users, and an utterance record of the topic word of the user is set as an edge connecting the user and the topic, based on a history of an utterance and a history of behavior of the user,
a relationship learning unit that obtains a learned embedding representation of each node by learning a graph neural network in which the learned user embedding representation and the topic embedding representation are each set as a feature amount of the node of the user and the node of the topic in the relationship graph, and
an embedding representation output unit that outputs the learned embedding representation of each node to the embedding representation input unit.
